(19) United States
(12) Patent Application Publication
(10) Pub. No.: US 2023/0410449 A1
(43) Pub. Date: Dec. 21, 2023

(54) INFORMATION PROCESSING SYSTEM, INFORMATION PROCESSING METHOD, AND PROGRAM

(71) Applicant: GREE, Inc., Tokyo (JP)

(72) Inventor: Akihiko SHIRAI, Kanagawa (JP)

(73) Assignee: GREE, Inc., Tokyo (JP)

(21) Appl. No.: 18/212,293

(22) Filed: Jun. 21, 2023

(30) Foreign Application Priority Data
Jun. 21, 2022 (JP) 2022-099302

(51) Int. Cl. G06T 19/20; G06T 13/40

(52) U.S. Cl. CPC G06T 19/20; G06T 2219/2016; G06T 2219/2004; G06T 13/40

(57) ABSTRACT

Disclosed is an information processing system that includes processing circuitry configured to dynamically change a setting value of a first control parameter or a second control parameter, the first control parameter being for controlling proximation distance or collision among a plurality of virtual reality mediums in a three-dimensional (3D) virtual space, and the second control parameter being for controlling a position travelable by the plurality of virtual reality mediums in the 3D virtual space. The processing circuitry is further configured to control, in a case in which the setting value is changed, a position or an orientation of the plurality of the virtual reality mediums based on the setting value.

### CROSS-REFERENCE TO RELATED APPLICATION

The present application claims priority to Japanese Application No. 2022-099302, filed on Jun. 21, 2022, the entire contents of which is incorporated by reference.

### BACKGROUND

### 1. Technical Field

The present disclosure relates to an information processing system, an information processing method, and a program.

### 2. Description of the Related Art

Conventionally, there is technology for controlling positional relation among avatars in a virtual space.

### SUMMARY

According to one aspect of the present disclosure, an information processing system is provided. The information processing system includes processing circuitry configured to dynamically change a setting value of a first control parameter or a second control parameter, the first control parameter being for controlling proximation distance or collision among a plurality of virtual reality mediums in a three-dimensional (3D) virtual space, and the second control parameter being for controlling a position travelable by the plurality of virtual reality mediums in the 3D virtual space. The processing circuitry is further configured to control, in a case in which the setting value is changed, a position or an orientation of the plurality of the virtual reality mediums based on the setting value.

### BRIEF DESCRIPTION OF THE DRAWINGS

FIG. 1 is a block diagram of a virtual reality generating system according to an embodiment;

FIG. 2 is an explanatory diagram of terminal images that are viewable via a head-mounted display;

FIG. 3 is an explanatory diagram of operation input by gesture;

FIG. 4 is an explanatory diagram of an example of virtual space that can be generated by the virtual reality generating system;

FIG. 5A is an explanatory diagram of a postural form of avatars in close proximity of each other;

FIG. 5B is an explanatory diagram of a postural form of avatars in close proximity of each other;

FIG. 6 is an explanatory diagram relating to proximity/collision control among avatars;

FIG. 7 is an explanatory diagram of an example of a dynamic switching method of a setting value (on/off state) of a control flag relating to proximity/collision control among avatars;

FIG. 8 is an explanatory diagram of another example of the dynamic switching method of the setting value (on/off state) of the control flag relating to proximity/collision control among avatars;

FIG. 9 is an explanatory diagram relating to execution conditions of proximity/collision control among avatars, based on an example of a form of change in distance between two certain avatars;

FIG. 10 is an explanatory diagram of an example of a dynamic switching method of the setting value (on/off state) of the control flag relating to proximity/collision control among avatars;

FIG. 11 is an explanatory diagram of another example of a dynamic switching method of the setting value (on/off state) of the control flag relating to proximity/collision control among avatars, and is tables showing on/off state of the control flag at three certain points in time;

FIG. 12 is an explanatory diagram of a case in which the control flag is associated with each correlation among avatars;

FIG. 13 is an explanatory diagram of a case in which the on/off state of the control flag is dynamically changed in accordance with a congestion degree relating to a particular space portion;

FIG. 14 is an explanatory diagram of a case in which the on/off state of the control flag is dynamically changed in accordance with a processing load of a server device;

FIG. 15 is an explanatory diagram of a case in which the on/off state of the control flag is dynamically changed in accordance with an action attribute or motion mode of each avatar;

FIG. 16 is an explanatory diagram relating to setting of a region in which each avatar is capable of traveling;

FIG. 17 is an explanatory diagram relating to setting of a region in which each avatar is capable of traveling;

FIG. 18 is an explanatory diagram of an example of a dynamic switching method of a value of traveling cost relating to traveling region control of each avatar;

FIG. 19 is a diagram illustrating a waiting-line form (before formation of waiting line) in a region in front of a particular shop;

FIG. 20 is a diagram illustrating a waiting-line form (during formation of waiting line) in the region in front of the particular shop;

FIG. 21 is an explanatory diagram of another example of a dynamic switching method of a value of traveling cost relating to traveling region control of each avatar;

FIG. 22 is an explanatory diagram of traveling cost for each traveling path of avatars;

FIG. 23 is a schematic block diagram illustrating functions of the server device relating to proximity/collision control and traveling region control among avatars;

FIG. 24 is an explanatory diagram showing an example of data within a user information storage unit;

FIG. 25 is an explanatory diagram showing an example of data within an avatar information storage unit;

FIG. 26 is a flowchart showing an example of processing that may be executed by the server device with relation to proximity/collision control among avatars; and

FIG. 27 is a schematic flowchart showing an example of proximity/collision control among avatars that is executed in step S2624 in FIG. 26.

FIG. 28 is a block diagram of processing circuitry that performs computer-based operations in accordance with the present disclosure.

### DETAILED DESCRIPTION

The inventors of the present disclosure have recognized that movement of avatars within a virtual space may be difficult to control. The inventors have developed the technology in the present disclosure to more accurately and easily control movement of avatars within a virtual space.

In an exemplary implementation, an information processing system includes a settings changing processing unit configured to dynamically change at least one of a setting value of a first control parameter or a setting value of a second control parameter, the first control parameter being a parameter for controlling proximation or collision among a plurality of virtual reality mediums in a three-dimensional virtual space, the second control parameter being a parameter for controlling a position travelable by the plurality of virtual reality mediums in the three-dimensional virtual space, and a position control unit configured to control, in a case in which the setting value is changed by the settings changing processing unit, a position or an orientation of the plurality of the virtual reality mediums based on the setting value after changing.

Embodiments will be described in detail below with reference to the attached drawings. Note that for the sake of ease of viewing, a plurality of parts each having the same attribute may be denoted only partially by reference symbols in the attached drawings.

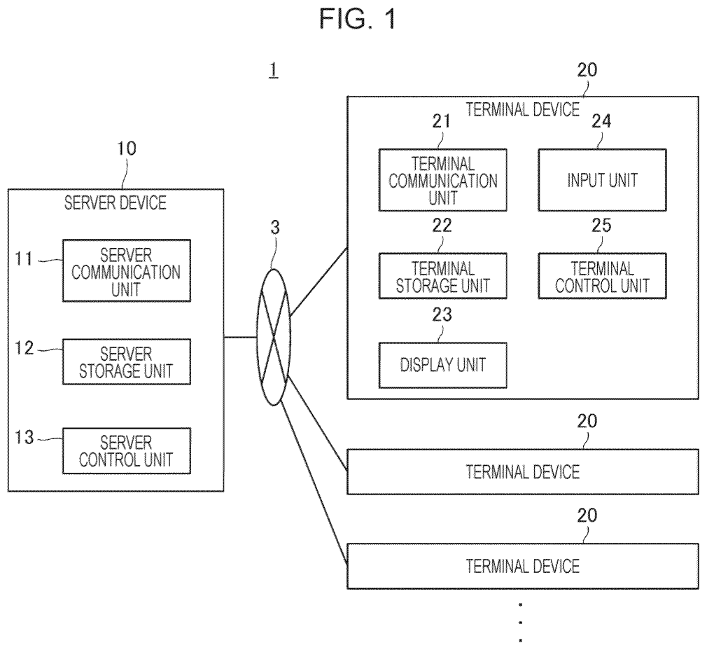

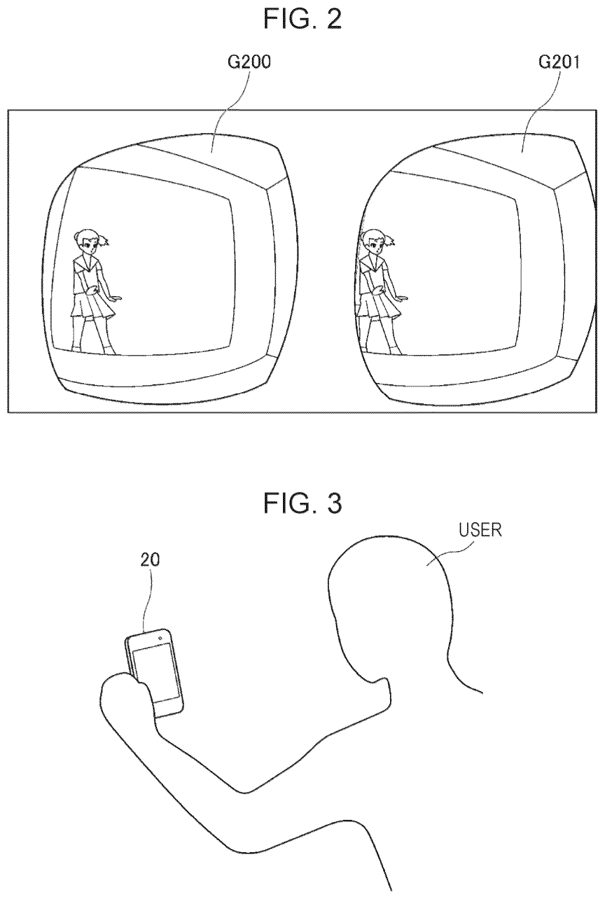

An overview of a virtual reality generating system 1 according to an embodiment of the present disclosure will be described with reference to FIG. 1. FIG. 1 is a block diagram of the virtual reality generating system 1 according to the present embodiment. FIG. 2 is an explanatory diagram of terminal images that are viewable via a head-mounted display.

The virtual reality generating system 1 includes a server device 10 and one or more terminal devices 20. Although three terminal devices 20 are illustrated in FIG. 1 for the sake of convenience, two or more is sufficient as the number of the terminal devices 20.

The server device 10 is an information processing system such as a server or the like managed by an operator providing, for example, one or more virtual realities. The terminal device 20 is a device used by a user, such as for example, a mobile telephone, a smartphone, a tablet terminal, a personal computer (PC), a head-mounted display, a gaming device, or the like. Typically, a plurality of terminal devices 20 can be connected to the server device 10 via a network 3 in different forms among users.

The terminal device 20 is capable of executing a virtual reality application according to the present embodiment. The virtual reality application may be received at the terminal device 20, via the network 3, from the server device 10 or a predetermined application distribution server or may be stored in advance in a storage device included in the terminal device 20 or in a storage medium such as a memory card or the like that is readable by the terminal device 20. The server device 10 and the terminal device 20 are communicably connected via the network 3. For example, the server device 10 and the terminal device 20 collaboratively operate to execute various types of processing relating to virtual reality.

The terminal devices 20 are communicably connected to each other via the server device 10. Note that hereinafter, the expression “one terminal device 20 transmits information to another terminal device 20” means “one terminal device 20 transmits information to another terminal device 20 via the server device 10”. Similarly, the expression “one terminal device 20 receives information from another terminal device 20” means “one terminal device 20 receives information from another terminal device 20 via the server device 10”. Note however that in a modification, the terminal devices 20 may be communicably connected without going through the server device 10.

Note that the network 3 may include a wireless communication network, the Internet, a virtual private network (VPN), a wide area network (WAN), a wired network, or any combination thereof, and so forth.

In the following, the virtual reality generating system 1 realizes an example of an information processing system, but individual elements (see terminal communication unit 21 to terminal control unit 25 in FIG. 1) of one particular terminal device 20 may realize an example of an information processing system, or a plurality of terminal devices 20 may collaboratively operate to realize an example of an information processing system. Also, the server device 10 may singularly realize an example of an information processing system, or the server device 10 and one or more terminal devices 20 may collaboratively operate to realize an example of an information processing system.

Now, an overview of virtual reality relating to the present embodiment will be described. The virtual reality according to the present embodiment is virtual reality regarding any realities, such as for example, education, travel, roleplaying, simulation, entertainment such as games and concerts, and so forth, and virtual reality mediums such as avatars are used to carry out the virtual reality. For example, the virtual reality according to the present embodiment may be realized by three-dimensional virtual space, various types of virtual reality mediums appearing in this virtual space, and various types of contents provided in this virtual space.

Virtual reality mediums are electronic data used in the virtual reality, and include any medium, such as for example, cards, items, points, in-service currencies (or in-virtual-reality currencies), tokens (e.g., non-fungible tokens (NFTs)), tickets, characters, avatars, parameters, and so forth. Also, virtual reality mediums may be virtual reality related information, such as level information, status information, parameter information (power value, attack capabilities, etc.) or capability information (skill, ability, incantation, job, etc.). Also, virtual reality mediums are electronic data that can be obtained, possessed, used, managed, traded, composited, strengthened, sold, discarded, gifted, or the like, by the user in virtual reality, but usage forms of the virtual reality mediums are not limited to those explicitly set forth in the present specification.

Note that an avatar is typically in a form of a character having a frontal direction, and may have a form of a person, an animal, or the like. An avatar can have various appearances (appearances when drawn) by being associated with various types of avatar items. Also, note that users and avatars may be referred to interchangeably in the following description, due to the nature of avatars. Accordingly, for example, “an avatar does so-and-so” may be used interchangeably with “a user does so-and-so”.

Users may each wear a worn device on part of the head or face, and view virtual space via the worn device. Note that the worn device may be a head-mounted display or a smart-glasses type device. The smart-glasses type device may be so-called augmented reality (AR) glasses or mixed reality (MR) glasses. In either case, the worn device may be separate from the terminal device 20 or may realize part or all of functions of the terminal device 20. The terminal device 20 may be realized by a head-mounted display, as an example.

### Configuration of Server Device

A configuration of the server device 10 will be described in detail. The server device 10 is made up of a server computer. The server device 10 may be realized by collaborative operation among a plurality of server computers. For example, the server device 10 may be realized by collaborative operation among a server computer that provides various types of contents, a server computer that realizes various types of authentication servers, and so forth. Also, the server device 10 may include a Web server. In this case, part of the functions of the terminal device 20, which will be described later may be realized by a browser processing Hypertext Markup Language (HTML) documents that are received from the Web server and various types of accompanying programs (JavaScript).

The server device 10 includes a server communication unit 11, a server storage unit 12, and a server control unit 13, as illustrated in FIG. 1.

The server communication unit 11 communicates with external devices by wireless or wired communication, and includes an interface for performing transmission and reception of information. The server communication unit 11 may include, for example a wireless local area network (LAN) communication module, a wired LAN communication module, or the like. The server communication unit 11 is capable of exchanging information with the terminal devices 20 via the network 3.

The server storage unit 12 is a storage device for example, and stores various types of information and programs that are necessary for various types of processing relating to virtual reality.

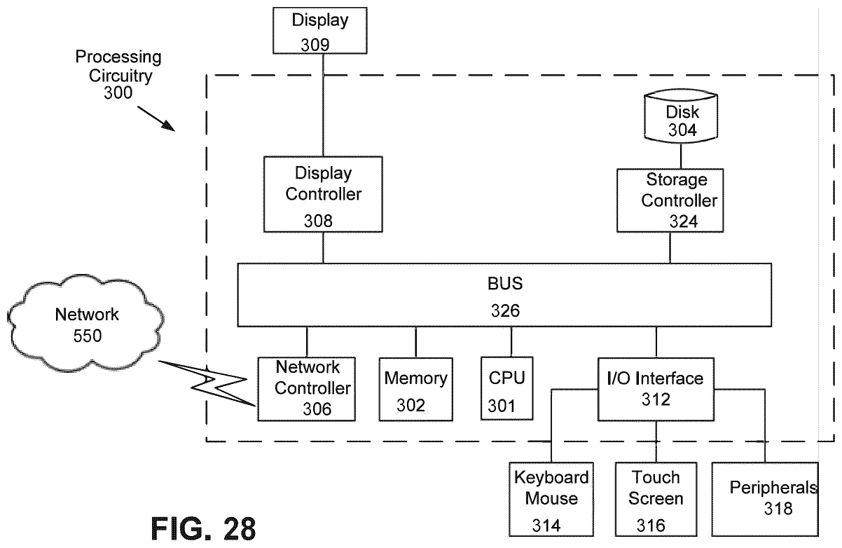

The server control unit 13 may include a dedicated microprocessor, or a central processing unit (CPU) for realizing particular functions by reading particular programs, a graphics processing unit (GPU), or the like. For example, the server control unit 13 collaboratively operates with the terminal device 20 to execute a virtual reality application in accordance with user input. In an exemplary implementation, server control unit 13 is processing circuitry, which will be discussed in detail below with respect to FIG. 28.

### Configuration of Terminal Device

A configuration of the terminal device 20 will be described. The terminal device 20 includes the terminal communication unit 21, a terminal storage unit 22, a display unit 23, an input unit 24, and the terminal control unit 25, as illustrated in FIG. 1.

The terminal communication unit 21 performs communication with an external device by wireless or wired communication, and includes an interface of performing transmission and reception of information. The terminal communication unit 21 may include a wireless communication module corresponding to a mobile communication standard such as, for example, long-term evolution (LTE) (registered trademark), LTE Advanced (LTE+), fifth generation mobile communication technology standard (5G), Ultra Mobile Broadband (UMB), and so forth, a wireless LAN communication module, a wired LAN communication module, or the like. The terminal communication unit 21 is capable of exchanging information with the server device 10 via the network 3.

The terminal storage unit 22 includes, for example, a primary storage device and a secondary storage device. The terminal storage unit 22 may include, for example, semiconductor memory, magnetic memory, optical memory, or the like. The terminal storage unit 22 stores various types of information and programs used for processing of virtual reality, which are received from the server device 10. The information and programs used for processing of virtual reality may be acquired from an external device via the terminal communication unit 21. For example, a virtual reality application program may be acquired from a predetermined application distribution server. Hereinafter, application programs may be referred to simply as “applications”.

Also, the terminal storage unit 22 may store data for drawing virtual space, such as for example, indoor space of buildings or the like, images of outdoor space, and so forth. Note that a plurality of types of data for drawing virtual space may be provided for each virtual space, and may be used separately depending on situations.

Also, the terminal storage unit 22 may store various types of images (texture images) to be projected (texture mapping) on various types of objects placed in three-dimensional virtual space.

For example, the terminal storage unit 22 stores avatar drawing information relating to an avatar serving as a virtual reality medium associated with each user. Avatars in the virtual space are drawn on the basis of the avatar drawing information relating to the avatars.

Also, the terminal storage unit 22 stores drawing information relating to various types of objects (virtual reality mediums) that are different from the avatars, such as for example, various types of gift objects, buildings, walls, non-player characters (NPCs), and so forth. The various types of objects are drawn in the virtual space on the basis of this drawing information. Note that gift objects are objects corresponding to gifts (presents) from one user to another user, and are part of items. Gift objects may be things to be worn by the avatar (clothing or accessories), things to decorate (fireworks, flowers, etc.), backgrounds (wallpaper) or the like, tickets for gacha such as opening a loot box (drawings), or the like. Note that the term “gift” as used in the present application means that same concept as the term “token”. Accordingly, the technology described in the present application can be understood by replacing the term “gift” with the term “token”.

The display unit 23 includes display devices such as, for example, liquid crystal displays, organic electroluminescent (EL) displays, and so forth. The display unit 23 is capable of displaying various types of images. The display unit 23 is made up of a touch panel, for example, and functions as an interface that detects various types of user operations. Note that the display unit 23 may have a form of being built into a head-mounted display, as described above.

The input unit 24 may include physical keys, and may further include any input interface, such as a pointing device like a mouse or the like. The input unit 24 may also be capable of accepting non-contact user input, such as speech input, gesture input, or gaze-tracking input. Note that gesture input may use sensors for detecting various types of states of the user (image sensors, acceleration sensors, distance sensors, etc.), dedicated movement capturing in which sensor technology and cameras are integrated, controllers such as joypads, and so forth. Also, a camera for detecting line of sight may be placed within the head-mounted display. Note that as described above, the various states of the user are, for example, orientation, position, movement, and so forth of the user, and in this case, the orientation, position, and movement of the user is a concept that is not limited to the orientation, position, movement, of part or all of the body of the user, such as face, hands, and so forth, and includes the orientation, position, movement, or the like of the line of sight of the user.

Note that operation input by gestures may be used to change the viewpoint of a virtual camera. For example, as schematically illustrated in FIG. 3, when a user holds the terminal device 20 in his/her hand and changes the orientation of the terminal device 20, the viewpoint of the virtual camera may be changed in accordance with that direction. In this case, a viewing region that is as broad as a view that can be enabled via a head-mounted display can be ensured, even in a case of using a terminal device 20 such as a smartphone or the like that has a relatively small screen.

The terminal control unit 25 includes one or more processors. The terminal control unit 25 controls the actions of the entire terminal device 20. In an exemplary implementation, terminal control unit 25 is processing circuitry, which will be discussed in detail below with respect to FIG. 28.

The terminal control unit 25 performs transmission and reception of information via the terminal communication unit 21. For example, the terminal control unit 25 receives various types of information and programs used for various types of processing relating to virtual reality from at least one of the server device 10 and another external server. The terminal control unit 25 stores the information and programs that are received at the terminal storage unit 22. For example, the terminal storage unit 22 may store a browser (Web browser) for connecting to a Web server.

The terminal control unit 25 activates a virtual reality application in accordance with operations of the user. The terminal control unit 25 executes various types of processing relating to virtual reality in collaborative operation with the server device 10. For example, the terminal control unit 25 displays an image of virtual space on the display unit 23. A graphical user interface (GUI) that detects user operations, for example, may be displayed on the screen. The terminal control unit 25 is capable of detecting user operations via the input unit 24. For example, the terminal control unit 25 is capable of detecting various types of operations through gestures of the user (operations corresponding to tap operations, long-tap operations, flick operations, swipe operations, and so forth). The terminal control unit 25 transmits operation information to the server device 10.

The terminal control unit 25 draws the avatar and so forth along with the virtual space (image), and performs display of terminal images on the display unit 23. In this case, for example, images G200 and G201 that are respectively viewed by the left and right eyes, may be generated to generate a three-dimensional image for a head-mounted display, as illustrated in FIG. 2. FIG. 2 schematically illustrates the images G200 and G201 that are respectively viewed by the left and right eyes. Note that hereinafter, “image of virtual space” refers to the entire image expressed by the images G200 and G201, unless stated otherwise in particular. Also, the terminal control unit 25 realizes various types of movement and so forth of the avatar within the virtual space, in accordance with various types of operations performed by the user, for example.

Note that the virtual space described below is a concept that also includes non-immersive space that is viewable using a smartphone or the like, as described above with reference to FIG. 3, and is not limited to immersive space that is viewable using a head-mounted display or the like, i.e., three-dimensional space with continuality through which users can freely move about via avatars (in the same way as in reality). Note that the non-immersive space that is viewable using a smartphone or the like may be three-dimensional space with continuality through which users can freely move about via avatars, or may be two-dimensional non-continuous space. Hereinafter, to distinguish therebetween, three-dimensional space with continuality through which users can freely move about via avatars may also be referred to as “metaverse space”.

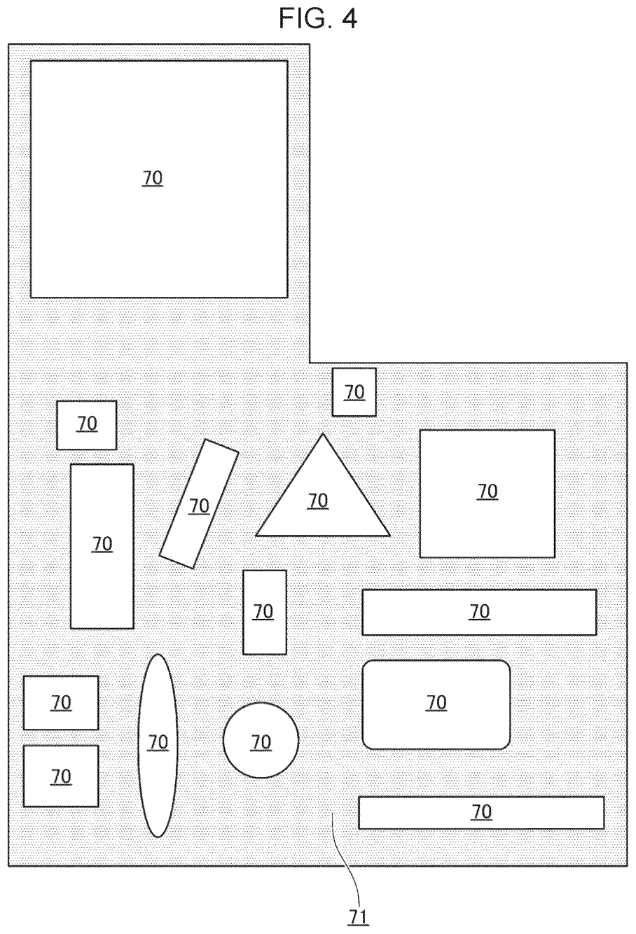

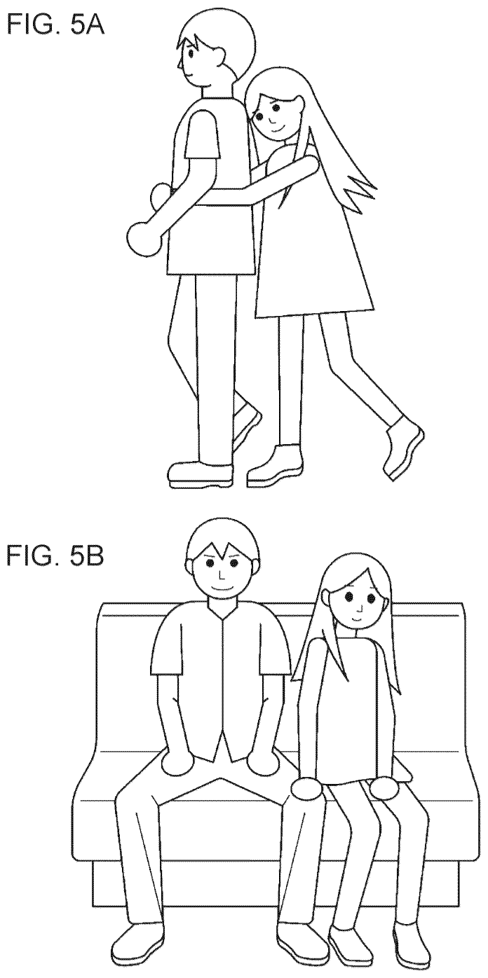

FIG. 4 is an explanatory diagram of an example of virtual space that can be generated by the virtual reality generating system.

In the example illustrated in FIG. 4, the virtual space includes a plurality of space portions 70 and a free space portion 71. Avatars are basically free to travel through the free space portion 71.

The space portions 70 may be space portions that are partitioned from the free space portion 71 at least partially by wall members (example of predetermined objects which will be described later) or traveling-restricted portions (example of predetermined objects which will be described later). For example, the space portions 70 may have entranceways (predetermined objects such as holes, doors, etc., for example) through which avatars can enter and exit the free space portion 71. Note that while the space portions 70 and the free space portion 71 are drawn as a two-dimensional plane in FIG. 4, the space portions 70 and the free space portion 71 may be set as three-dimensional space. For example, the space portions 70 and the free space portion 71 may be space having walls and a ceiling in a range corresponding to the planar form illustrated in FIG. 4 as a floor. Also, the virtual space may be, separate from the example illustrated in FIG. 4, a space having a considerable height such as a dome, a sphere, or the like, an architectural structure such as a building or the like, a particular location on Earth, or also a world mimicking outer space or the like where avatars can fly about.

Now, many avatars can freely move about in a metaverse space, and accordingly a plurality of avatars can come into proximity with each other or collide. With respect to this point, avatars coming into proximity with each other (including coming into contact) such as schematically illustrated in FIGS. 5A and 5B is advantageous with regard to promoting interchange among avatars, but this can also lead to trouble among avatars.

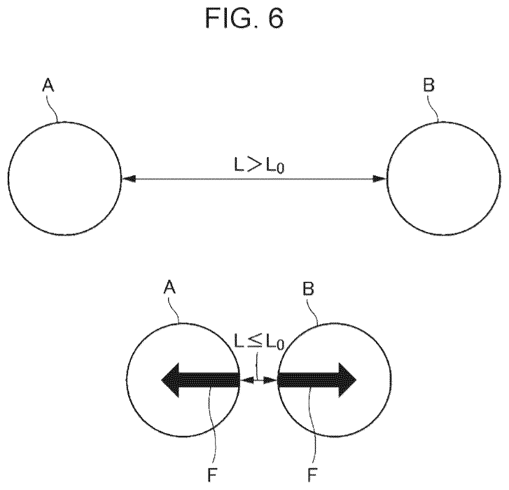

With respect to this point, controlling proximation distance between a plurality of avatars or collision between plurality of avatars (hereinafter also referred to as “proximity/collision control among avatars”) is effective in metaverse space. Conceivable examples of such types of proximity/collision control among avatars include, in a case in which a distance L (proximation distance) between an avatar A and an avatar B is no greater than a predetermined distance Lo that is a threshold value, such as schematically illustrated in plan view in FIG. 6, control of generating a reactive force F, control of placing a virtual wall (an invisible wall) or the like, or the like, to suppress the avatar A and the avatar B from coming into further proximity with each other.

However, with this type of control (control relating to proximation distance being less than a threshold or collision among a plurality of avatars) necessitates monitoring of the distances L and so forth among a great number of avatars, and accordingly a processing load thereof tends to become great.

Accordingly, a first aspect of the present embodiment is to efficiently realize proximity/collision control among avatars, which will be described below in detail. In an exemplary implementation, such proximity/collision control among avatars may further include controlling a posture, attitude, position, pose or form of one or more avatars.

Note that the distance L between the avatar A and the avatar B may be calculated as a distance between representative positions, such as centers (e.g., centers of gravity) of the avatars (distance between two positions or Euclidian distance as projected on a two-dimensional plane), or may be calculated as a shortest distance between virtual capsules covering each avatar (shortest Euclidian distance). In this case, just one virtual capsule may be set for each avatar, or may be set for each of parts with finer granularity, such as one for each of the head, arms, torso, and so forth, for example. In this case, when an avatar reaches out and touches another avatar for example, this contact can be detected.

Note that proximation distance being less than a threshold or collision can occur among avatars and objects other than avatars in a metaverse space, and in this case as well, the same control as the proximity/collision control among avatars is applicable.

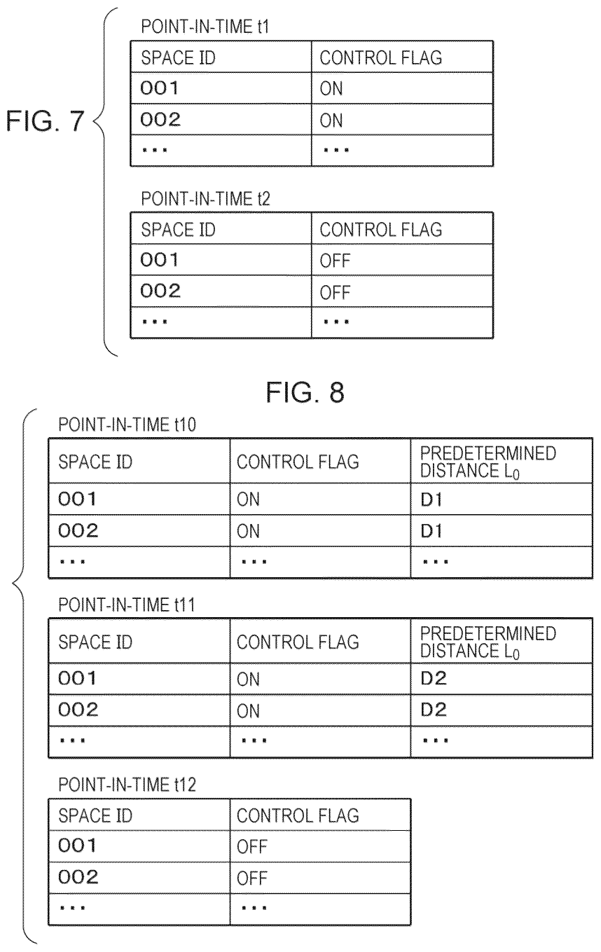

FIG. 7 is an explanatory diagram of an example of a dynamic switching method of a setting value (on/off state) of a control flag relating to proximity/collision control among avatars, and is a table showing the on/off state of the control flag at two certain points in time (point-in-time t1 and point-in-time t2). When the control flag is in an on state, the proximity/collision control among avatars is in an on state, and when the control flag is in an off state, the proximity/collision control among avatars is in an off state. In the on state of the proximity/collision control among avatars, the proximity/collision control among avatars is executable, and in the off state of the proximity/collision control among avatars, the proximity/collision control among avatars is not executable.

In the example shown in FIG. 7, the setting value of the control flag (example of first control parameter) is associated with each space ID. In this case, the space IDs may be identifiers that are given to the respective space portions 70 and the free space portion 71 such as those illustrated in FIG. 4.

In the example shown in FIG. 7, at point-in-time t1, the control flag is “on” (example of second setting value) with respect to space IDs “001”, “002”, and so forth, while at point-in-time t2, the control flag is “off” (example of first setting value) with respect to space IDs “001”, “002”, and so forth. Accordingly, in the space portions associated with the space IDs “001”, “002”, and so forth, the proximity/collision control among avatars can be executed at point-in-time t1, but the proximity/collision control among avatars will not be executed at point-in-time t2.

Thus, according to the present embodiment, by dynamically changing the setting value (on/off state) of the control flag, the on or off state of the proximity/collision control among avatars can be dynamically changed. In particular, according to the example shown in FIG. 7, dynamically changing the setting value (on/off state) of the control flag associated with each space ID enables the on or off state of the proximity/collision control among avatars for each space portion to be dynamically changed. Accordingly, for example, in a case in which the processing load of the server device 10 is no lower than a threshold value load (example of first predetermined threshold value), the processing load of the server device 10 can be reduced by setting the proximity/collision control among avatars to off at a plurality of space portions, as in the state in point-in-time t2.

Note that in the example shown in FIG. 7, the setting value of the control flag is associated with each space ID, and thus a state can be implemented in which the proximity/collision control among avatars is on for a part of the space portions at a certain point in time, while the proximity/collision control among avatars is off at other space portions. Accordingly, in the example shown in FIG. 7, the on or off state of the proximity/collision control among avatars can be dynamically changed depending on the types or attributes of the space portions, the current situation thereof (e.g., how crowded with avatars the space portions are), and so forth.

FIG. 8 is an explanatory diagram of another example of a dynamic switching method of the setting value (on/off state) of the control flag relating to the proximity/collision control among avatars, and is a table showing the on/off state of the control flag at three certain points in time (point-in-time t10 to point-in-time t12).

In the example shown in FIG. 8, at point-in-time t10 and point-in-time t11, the control flag is “on” with respect to space IDs “001”, “002”, and so forth, while at point-in-time t12, the control flag is “off” with respect to space IDs “001”, “002”, and so forth. Accordingly, in the space portions associated with the space IDs “001”, “002”, and so forth, the proximity/collision control among avatars can be executed at point-in-time t10 and point-in-time t11, but the proximity/collision control among avatars will not be executed at point-in-time t12.

Also, in the example illustrated in FIG. 8, the control flag is “on” at both point-in-time t10 and point-in-time t11, but the predetermined distance L₀ that is the threshold value described above with reference to FIG. 6 (the threshold value relating to the proximity/collision control among avatars) is set to different values at point-in-time t10 and at point-in-time t11. Specifically, the predetermined distance L₀ is D1 at point-in-time t10, but the predetermined distance L₀ is D2 at point-in-time t11. In this case, the distance D1 and the distance D2 are significantly different from each other. Accordingly, while the proximity/collision control among avatars is executed at point-in-time t10 and point-in-time t11 in the example shown in FIG. 8, conditions of execution of the proximity/collision control among avatars differ between point-in-time t10 and point-in-time t11. For example, when distance D2<distance D1 holds, the proximity/collision control among avatars is executed less readily at point-in-time t11 than at point-in-time t10.

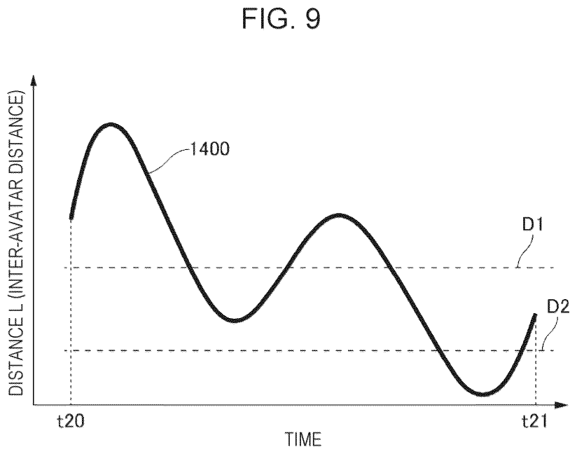

FIG. 9 shows a time-series waveform 1400 in which the horizontal axis is time and the vertical axis is a distance L (inter-avatar distance), and which shows an example of a form of change in the distance L between two certain avatars (e.g., avatar A and avatar B illustrated in FIG. 6). Note that the time-series waveform 1400 will be assumed to be a waveform for a period from point-in-time t20 to point-in-time t21. FIG. 9 shows the distance D1 and the distance D2 with respect to the time-series waveform 1400.

In a case in which the state at the above-described point-in-time t10 (control flag on, and predetermined distance L₀ of D1) is maintained over the period from point-in-time t20 to point-in-time t21, the time-series waveform 1400 does not fall below the distance D1, but in a case in which the control flag is in the off state and the proximity/collision control among avatars is not executed, the time-series waveform 1400 will fall below the distance D1 two times. Accordingly, in this case, control for forcibly increasing the distance among the avatars (e.g., the above described control of generating the reactive force F, or the like) of the proximity/collision control among avatars will be executed two times during the period from point-in-time t20 to point-in-time t21. In comparison with this, in a case in which the state at the above-described point-in-time t11 (control flag on, and predetermined distance L₀ of D2) is maintained over the period from point-in-time t20 to point-in-time t21, the time-series waveform 1400 does not fall below the distance D2, but in a case in which the control flag is in the off state and the proximity/collision control among avatars is not executed, the time-series waveform 1400 will fall below the distance D2 one time. Accordingly, in this case, control for forcibly increasing the distance among the avatars (e.g., the above described control of generating the reactive force F, or the like) of the proximity/collision control among avatars will be executed one time during the period from point-in-time t20 to point-in-time t21. Thus, the smaller the predetermined distance L₀ is, the less readily the control for forcibly increasing the distance among the avatars of the proximity/collision control among avatars is executed. In this way, the control flag switches to on at the point-in-time t at which predetermined distance L₀=D1 and/or predetermined distance L₀=D2 holds, and the control flag switches to off at the point-in-time t at which predetermined distance L₀>D1 and/or predetermined distance L₀>D2 holds.

The reactive force F generated among avatars can be implemented by rules for not invading the distances D1 and D2 each other. For example, as for control to generate the above-described reactive force F, a “spring model” in dynamics may be used to increase reactive force in accordance with a distance between two points. However, in a case of the “spring model”, there may be situations in which control is difficult when the distances D1 and D2 are drastically small, or when latency of the network is great. Further, when a great number of “spring models” are set, a situation can occur in which reaction among models generate vibrations. In such a case, a “damper model” or a “spring-damper model” may be used instead of the “spring model”. In a case of using such a model according to dynamics, the weight of each avatar and the weight of equipment can be taken into consideration as necessary, thereby enabling application to expressions such as heavy avatars or large avatars being sluggish when moving. Note that when such models according to dynamics are used, consideration is given to not generating inertia when avatars collide and move away from each other, so that the distance therebetween does not change any further, and such that avatars do not become lodged in each other.

In this way, according to the example illustrated in FIG. 8, the proximity/collision control among avatars can be limited stepwise in accordance with the increase in the processing load of the server device 10, for example. For example, an arrangement may be made in which in a case of the processing load of the server device 10 reaching a first threshold value load or greater, the proximity/collision control among avatars is executed less readily, as in the state at point-in-time t11, and in a case of the processing load of the server device 10 reaching a second threshold value load, which is significantly higher than the first threshold value load, or greater, the proximity/collision control among avatars is set to off, as in the state at point-in-time t12. In this case, the processing load of the server device 10 can be reduced in accordance with increase in the processing load of the server device 10.

In the examples described with reference to FIGS. 7 to 9, setting values of the control flag are associated with respective space portions, but any granularity may be used as the granularity of space portions to which setting values of the control flag are associated, and may be associated with positions in virtual space according to any form. Also, the increments of positions to which setting values of the control flag are associated (granularity of space portions) may be dynamically changed. Also, instead of setting values of the control flag being associated with the respective space portions, setting values of the control flag may be associated equivalently in respective regions. For example, the control flag may be associated with a region in front of a particular shop (shop in the metaverse), a plaza, or the like, and in this case, the degree of congestion and so forth in the region in front of the particular shop, the plaza, or the like, can be dynamically adjusted. Note that the space portions and regions are sets of positions, and accordingly, a state in which the setting value of the control flag is associated with one space portion or region is equivalent to a state in which the setting value of the control flag is associated with each position included in the one space portion or region.

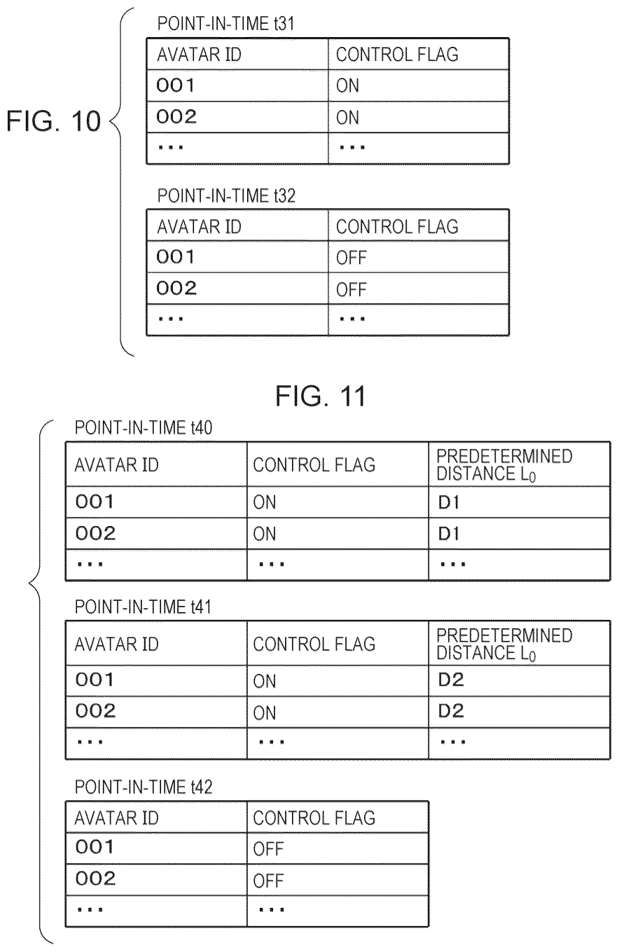

FIG. 10 is an explanatory diagram of yet another example of a dynamic switching method of the setting value (on/off state) of the control flag relating to the proximity/collision control among avatars, and is tables showing on/off state of the control flag at two certain points in time (point-in-time t31 and point-in-time t32).

In the example shown in FIG. 10, the setting value of the control flag is associated with each avatar, and at point-in-time t31, the control flag is “on” with respect to avatar IDs “001”, “002”, and so forth, while at point-in-time t32, the control flag is “off” with respect to avatar IDs “001”, “002”, and so forth. Accordingly, with respect to the avatars associated with the avatar IDs “001”, “002”, and so forth, the proximity/collision control among avatars can be executed at point-in-time t31, while the proximity/collision control among avatars will not be executed at point-in-time t32.

Thus, according to the present embodiment, by dynamically changing the setting value (on/off state) of the control flag, the on or off state of the proximity/collision control among avatars can be dynamically changed. In particular, according to the example shown in FIG. 10, dynamically changing the setting value (on/off state) of the control flag associated with each avatar ID enables the on or off state of the proximity/collision control among avatars for each avatar to be dynamically changed. Accordingly, for example, in a case in which the processing load of the server device 10 is no lower than a threshold value load, the processing load of the server device 10 can be reduced by setting the proximity/collision control among avatars to off regarding particular avatars, as in the state in point-in-time t32.

Note that in the example shown in FIG. 10, the setting value of the control flag is associated with each avatar, and thus a state can be implemented in which the proximity/collision control among avatars is on for a part of the avatars at a certain point in time, while the proximity/collision control among avatars is off at other avatars. Accordingly, in the example shown in FIG. 10, the on or off state of the proximity/collision control among avatars can be dynamically changed depending on the types, attributes, and so forth, of the avatars.

FIG. 11 is an explanatory diagram of yet another example of a dynamic switching method of the setting value (on/off state) of the control flag relating to the proximity/collision control among avatars, and is tables showing on/off state of the control flag at three certain points in time (point-in-time t40 to point-in-time t42).

In the example shown in FIG. 11, at point-in-time t40 and at point-in-time t41, the control flag is “on” with respect to avatar IDs “001”, “002”, and so forth, while at point-in-time t42, the control flag is “off” with respect to avatar IDs “001”, “002”, and so forth. Accordingly, the proximity/collision control among avatars can be executed at point-in-time t40 and point-in-time t41 with respect to the avatars associated with the avatar IDs “001”, “002”, and so forth, but the proximity/collision control among avatars will not be executed at point-in-time t42.

Also, in the example illustrated in FIG. 11, the control flag is “on” at both point-in-time t40 and point-in-time t41, but the predetermined distance L₀ that is the threshold value described above with reference to FIG. 6 (the threshold value relating to the proximity/collision control among avatars) is set to different values among point-in-time t40 and point-in-time t41. Specifically, the predetermined distance L₀ is D1 at point-in-time t40, but the predetermined distance L₀ is D2 at point-in-time t41. In this case, when distance D2<distance D1 holds, the proximity/collision control among avatars is executed less readily at point-in-time t41 than at point-in-time t40, in the same way as the case described above with reference to FIGS. 8 and 9, for example.

In this way, according to the example shown in FIG. 11, the proximity/collision control among avatars can be limited stepwise in accordance with the increase in the processing load of the server device 10, for example. For example, an arrangement may be made in which in a case of the processing load of the server device 10 reaching the first threshold value load or greater, the proximity/collision control among avatars is executed less readily, as at point-in-time t41, and in a case of the processing load of the server device 10 reaching the second threshold value that is significantly higher than the first threshold value load or greater, the proximity/collision control among avatars is set to off, as in the state at point-in-time t42. In this case, the processing load of the server device 10 can be reduced in accordance with increase in the processing load of the server device 10.

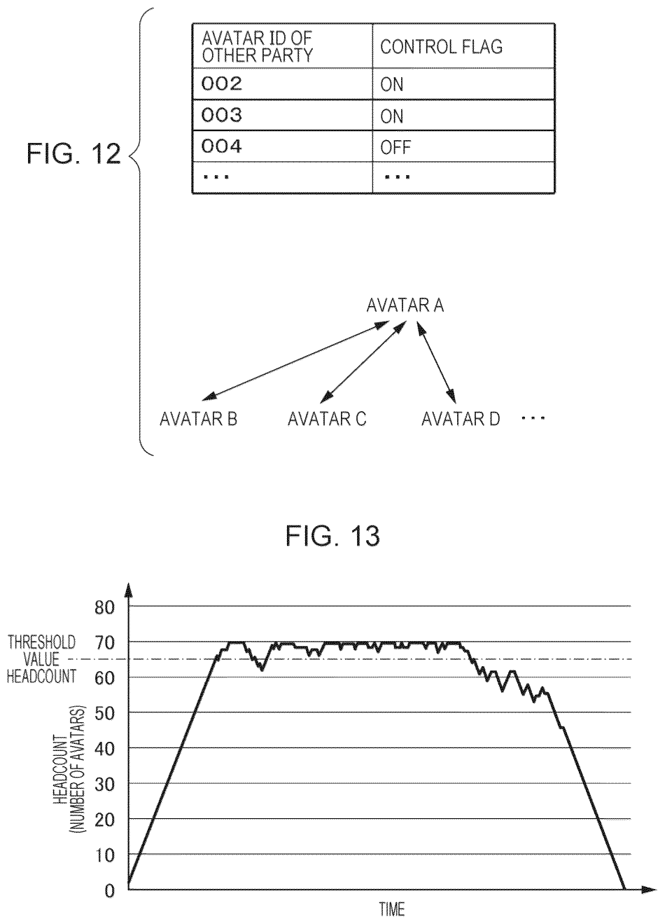

Now, while setting values of the control flag are associated with respective avatars in the examples shown in FIGS. 10 and 11, setting values of the control flag may be associated with correlations among avatars. FIG. 12 is an explanatory diagram of a case in which setting values of the control flag are associated with correlations among avatars.

The example shown in FIG. 12 relates to one particular avatar (avatar A of avatar ID “001” here). FIG. 12 shows an example of a table (upper side) of a state of setting values (on/off state) of the control flag with regard to the relation with other avatars with the one particular avatar as a reference. FIG. 12 also shows, to the lower side, an explanatory diagram of the table to the upper side. The avatars of the avatar IDs “002”, “003”, and “004” will be referred to here as avatars B, C, and D, respectively.

In the example shown in FIG. 12, the avatar A has the control flag set to on with respect to the avatar B and the avatar C, and has the control flag set to off with respect to the avatar D. In this case, the control flag is “on” between the avatar A and the avatar B or the avatar C, but the control flag is “off” between the avatar A and the avatar D. Accordingly, in this case, the proximity/collision control among avatars can be executed between the avatar A and the avatar B or the avatar C, but the proximity/collision control among avatars will not be executed between the avatar A and the avatar D.

Thus, according to the example shown in FIG. 12, the setting values of the control flag are associated with correlations among avatars, and accordingly, a state can also be implemented in which the proximity/collision control among avatars is on with respect to certain avatars, the proximity/collision control among avatars is off with respect to other avatars. Therefore, for example, in the example shown in FIG. 12, in a case in which the avatar A and the avatar D are in a friendship relation, inconvenient situations in which interchange between the avatar A and the avatar D (e.g., close proximity forms such as illustrated in FIGS. 5A and 5B) is blocked, due to the proximity/collision control between the avatars, can be reduced.

Note that while the predetermined distance L₀ is constant in the example shown in FIG. 12, the predetermined distance L₀ may be enabled to differ for each correlation among avatars, as shown in FIG. 11 and so forth. Also, in the example shown in FIG. 12, the on/off state of the control flag may be dynamically changed for each correlation among avatars, as described above with reference to FIGS. 7 and 8, and so forth.

Next, an example of a method of dynamically changing the setting values (on/off state) of the control flag will be described with reference to FIGS. 13 to 15.

While any method may be used as the method of dynamically changing the setting values (on/off state) of the control flag, the on/off state of the control flag may be changed on the basis of varied parameters, such as the processing load of the server device 10, congestion degree of space portion (degree of how congested with avatars), attributes of avatars themselves, action attributes of avatars, motion modes, and so forth.

FIG. 13 is an explanatory diagram of a case in which the on/off state of the control flag is dynamically changed in accordance with the congestion degree relating to a particular space portion 70. FIG. 13 shows a time-series waveform of the number of avatars in a particular space portion 70, in which the horizontal axis is time and the vertical axis is the headcount (number of avatars) within the particular space portion 70. The congestion degree within the space portion 70 may be evaluated by, besides the number of connection sessions to the server device 10, rendering costs for drawing in the space portion 70, the narrowness of the space portion 70 (collisions occur more readily in space portions 70 such as narrow passageways), calculation amount of physical simulations of flexible objects, such as hair and clothing that is worn, and so forth, which move separately from the intent of the avatars, integral value of the speed of travel of individual avatars (fast-moving avatars collide more readily), and so forth.

In this case, in a case in which the number of avatars within a particular space portion 70 exceeds a threshold value headcount set in advance with regard to that particular space portion 70, for example, the control flag associated with the space ID related to the particular space portion 70 may be set to on. That is to say, in a case in which the number of avatars within the particular space portion 70 is no greater than the threshold value headcount, the control flag is off, and the proximity/collision control among avatars is not executed. On the other hand, in a case in which the number of avatars within the particular space portion 70 exceeds the threshold value headcount, the control flag is set to on, and the proximity/collision control among avatars can be executed. Accordingly, inconvenience of an excessively great number of avatars within the particular space portion 70 can be reduced. Note that in the example illustrated in FIG. 13, the threshold value headcount is set to 65, for example, and sudden increase in the number of avatars is suppressed from the point in time that the number exceeds 65.

Note that the threshold value headcount may be set as appropriate in accordance with the size, attributes, and so forth of the particular space portion 70, and may be dynamically changed. For example, the threshold value headcount may be set to be greater, the larger the size of the particular space portion 70 is. Also, in a case in which the particular space portion 70 is an event venue, the threshold value headcount may be set to be great, and in a case in which the particular space portion 70 is a conference room, the threshold value headcount may be set to be relatively small. Also, the threshold value headcount may be set to be greater just in a time span in which congestion is predicted, as compared to other time spans.

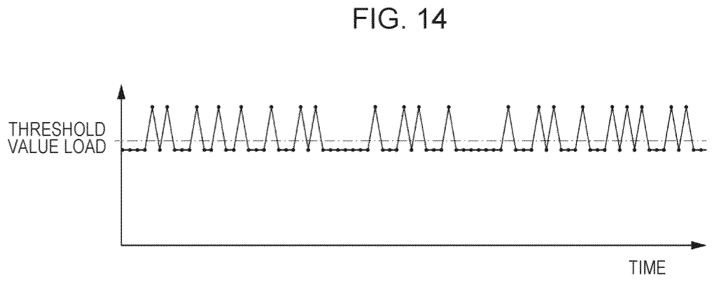

FIG. 14 is an explanatory diagram of a case in which the on/off state of the control flag is dynamically changed in accordance with the processing load of the server device 10. FIG. 14 shows a time-series waveform of an index value of the processing load of the server device 10, in which the horizontal axis is time and the vertical axis is the index value of the processing load of the server device 10. Note that the index value of the processing load of the server device 10 may include CPU usage rate, memory usage amount, and so forth. Also, the index value of the processing load of the server device 10 may include throughput, packet loss, latency, and so forth, as index values relating to communication capabilities of the network 3 (transmission path).

In this case, the control flag may be set to off in a case in which the processing load of the server device 10 exceeds the threshold value load, for example. That is to say, in a case in which the processing load of the server device 10 exceeds the threshold value load, the control flag is set to off, and the proximity/collision control among avatars is not executed. On the other hand, in a case in which the processing load of the server device 10 does not exceed the threshold value load, the control flag is set to on, and the proximity/collision control among avatars can be executed. Accordingly, inconvenience due to execution of proximity/collision control among avatars in a state in which the processing load of the server device 10 is relatively high (e.g., further increase in the processing load of the server device 10) can be reduced.

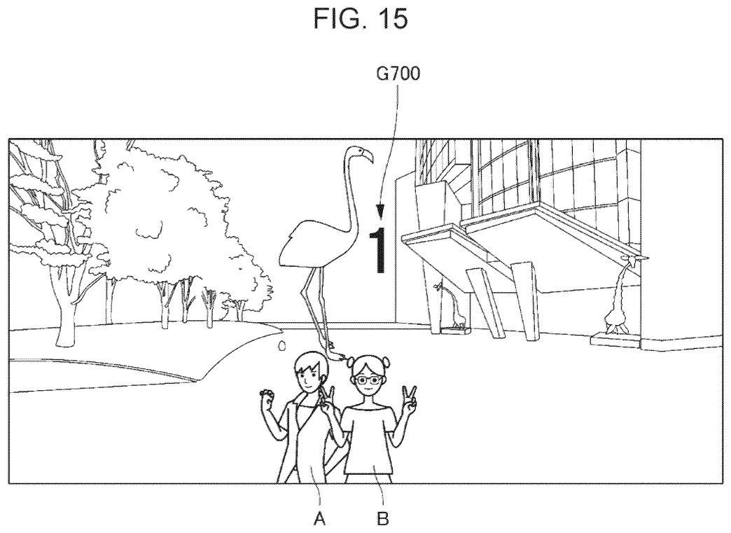

FIG. 15 is an explanatory diagram of a case in which the on/off state of the control flag is dynamically changed in accordance with an action attribute or motion mode of each avatar. FIG. 15 illustrates two people, the avatar A and the avatar B, who are taking a commemorative photograph at a commemorative photograph spot. Note that the numeral “1” denoted by G700 in FIG. 15 indicates a countdown for the commemorative photograph (countdown until the shutter timing).

In this case, the control flag may be set to off in a case in which the action attribute or the motion mode of the avatar A and the avatar B is an action attribute or a motion mode for a group event, for example. Accordingly, in a case in which the action attribute or the motion mode of the avatar A and the avatar B is an action attribute or a motion mode for a group event, the proximity/collision control among avatars is not executed. On the other hand, in a case in which the action attribute or the motion mode of the avatar A and the avatar B is an action attribute or a motion mode for another object (e.g., simply traveling), the control flag may be set to on. Thus, the possibility of inappropriately blocking, due to the proximity/collision control among avatars, group events held by a plurality of avatars for enlivenment of the metaverse space can be reduced.

Now, while the metaverse space is a “virtual” space in which a great many avatars can freely move about as described above, if regions in which each avatar is capable of traveling are set to be unlimited, there is concern that the movement of each avatar cannot be appropriately limited.

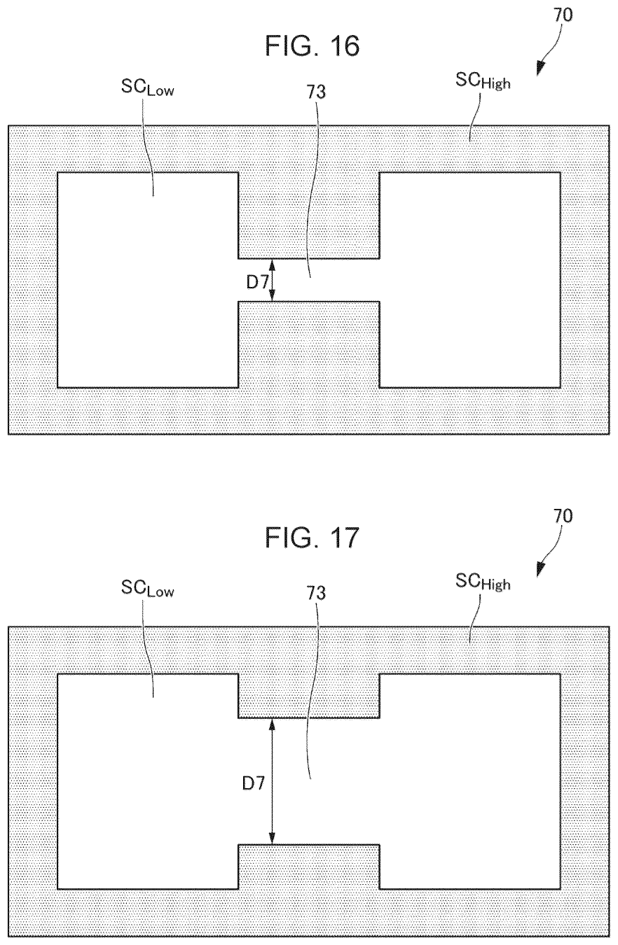

With respect to this point, in the metaverse space, control to restrict regions in which each avatar is capable of traveling (hereinafter, “travel region control of each avatar”, or simply “travel region control”) is effective. For example, as schematically illustrated in plan view in FIGS. 16 and 17, a method of controlling a width D7 of a passageway region 73 in a space portion 70 in the metaverse space (the same for the free space portion 71 as well) or the like is conceivable. Note that in FIG. 16, the width D7 of the passageway region 73 is controlled (set) to be smaller than that in FIG. 17. Control of making the width D7 of the passageway region 73 smaller may be realized by, for example, substantially making a cost of avatars when passing through the passageway region 73 (hereinafter also referred to as “traveling cost”) to be significantly smaller than the traveling cost of avatars when passing on either side of the passageway region 73. For example, in the example illustrated in FIG. 16, a region SC_{High} represents a region in which the traveling cost for avatars to pass is relatively high, and a region SC_{Low} represents a region in which the traveling cost for avatars to pass is relatively low.

However, if control parameters (e.g., the traveling cost described above) relating to this type of control (travel region control of each avatar) are fixed and do not dynamically change, realizing both convenience relating to ease of travel of the avatars and establishing various types of order (rules) in the metaverse becomes difficult. For example, if there is a popular shop that many avatars visit, from an avatar perspective, being able to do away with the presence of other avatars and directly reach this shop would be convenient, but from the perspective of the shop side or metaverse operator side, there are cases in which visiting of the shop by the avatars is realized with a certain level of order. For example, being able to appropriately express the congestion degree of this shop with avatars (avatar density), waiting lines of avatars waiting in order, and so forth, would clarify various types of order (rules) and result in confusion or the like among avatars from occurring less readily.

Accordingly, a second aspect of the present embodiment is to effectively realize travel region control of each avatar, which will be described below.

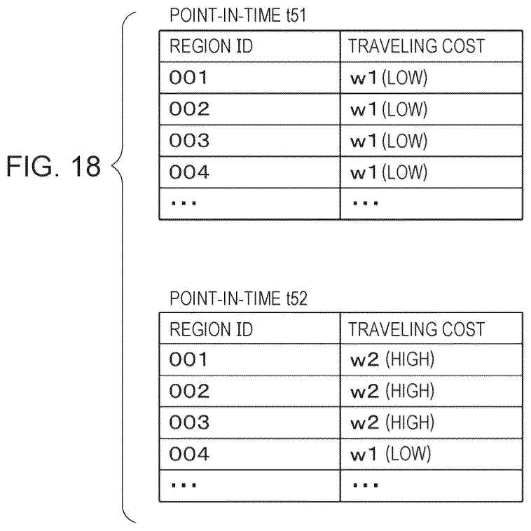

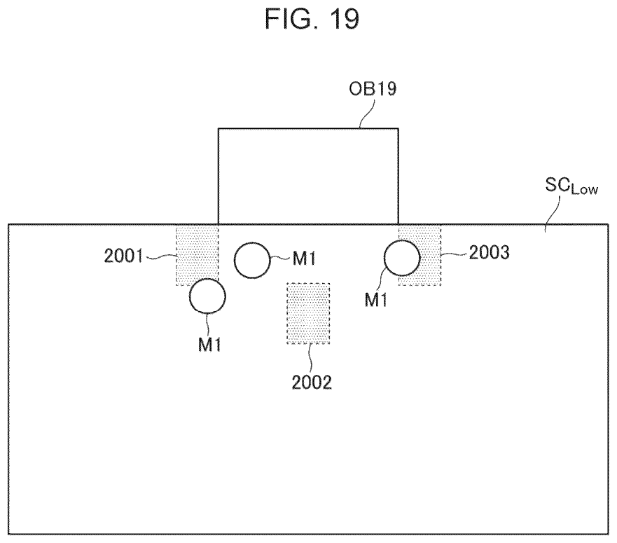

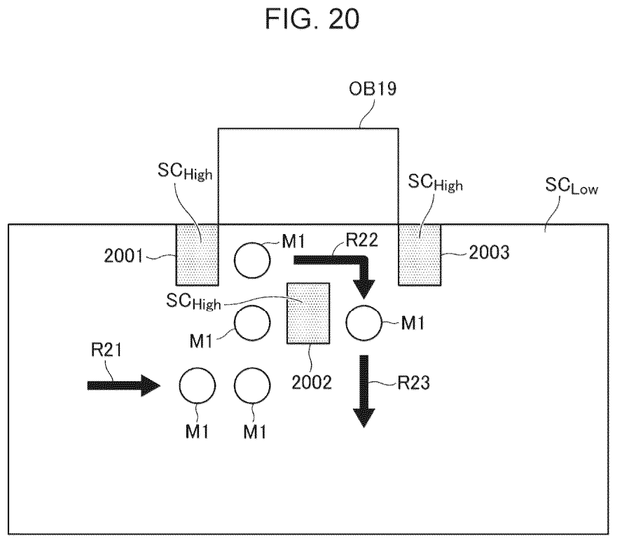

FIG. 18 is an explanatory diagram of an example of a dynamic switching method of a value of traveling cost relating to traveling region control of each avatar, and is tables showing values of traveling costs at two certain points in time (point-in-time t51 and point-in-time t52). FIGS. 19 and 20 are explanatory diagrams of FIG. 18, and are diagrams illustrating a waiting-line form in a region in front of a particular shop (see object OB19 relating to the shop).

In FIG. 18, a value for the traveling cost (example of second control parameter) is associated with each region ID with which each of a plurality of the regions within the metaverse space is imparted. When the value of the traveling cost associated with one region is w1, this represents that the cost for avatars to pass through this region (the difficulty of passage) is relatively low (i.e., relatively easy to pass). On the other hand, when the value of the traveling cost associated with one region is w2, this represents that the cost for avatars to pass through this region (the difficulty of passage) is relatively high (i.e., relatively difficult to pass).

Note that a region is a set of positions, and accordingly a state in which a setting value of the traveling cost is associated with one region may be equivalent to a state in which the setting value of the traveling cost is associated with each position included in the one region. Also, the setting value of the traveling cost may be associated with a space portion instead of a region, and in this case, a state in which a setting value of the traveling cost is associated with one space portion is equivalent to a state in which the setting value of the traveling cost is associated with each position included in the one space portion.

Regions 2001, 2002, and 2003, which relate to the region IDs “001”, “002”, and “003” in the example shown in FIG. 18 are regions in front of the particular shop (see object OB19 relating to the shop), for example, as illustrated in FIG. 20, and are regions for forming a waiting line. Also, a region relating to the region ID “004” in the example shown in FIG. 18 may be another nearby region (nearby region of the particular shop). Note that the way in which regions are divided may be changeable as appropriate by a user of the shop or the like.

In the example illustrated in FIG. 18, the value w1 of the traveling cost is associated with region IDs “001” to “004” at point-in-time t51, while the value w2 of the traveling cost is associated with region IDs “001” to “003” and the value w1 of the traveling cost is associated with region ID “004” at point-in-time t52. The value w2 of the traveling cost will be assumed here to be significantly higher than the value w1 of the traveling cost.

Accordingly, the regions 2001, 2002, and 2003 that are associated with the region IDs “001” to “003” are relatively easy for avatars to pass at point-in-time t51, but become difficult for avatars to pass at point-in-time t52. As a result, a waiting line of avatars can be formed in front of the particular shop (see object OB19 relating to the shop), as illustrated in FIG. 20. For example, an avatar that is a new customer lines up at the end of the waiting line (see arrow R21), and users that purchased products can smoothly leave from an exit side (see arrows R22 and R23). In this case, a form of the avatars visiting the shop can be realized with a certain level of order, even for popular shops or the like, as described above. Also, avatars nearby can easily recognize that the shop is popular, by seeing the waiting line being formed in front of the particular shop.

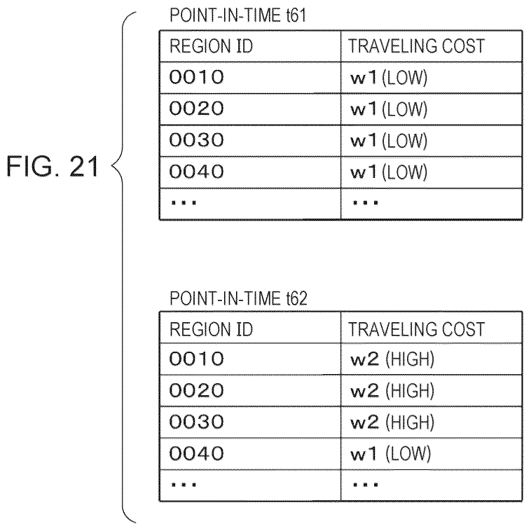

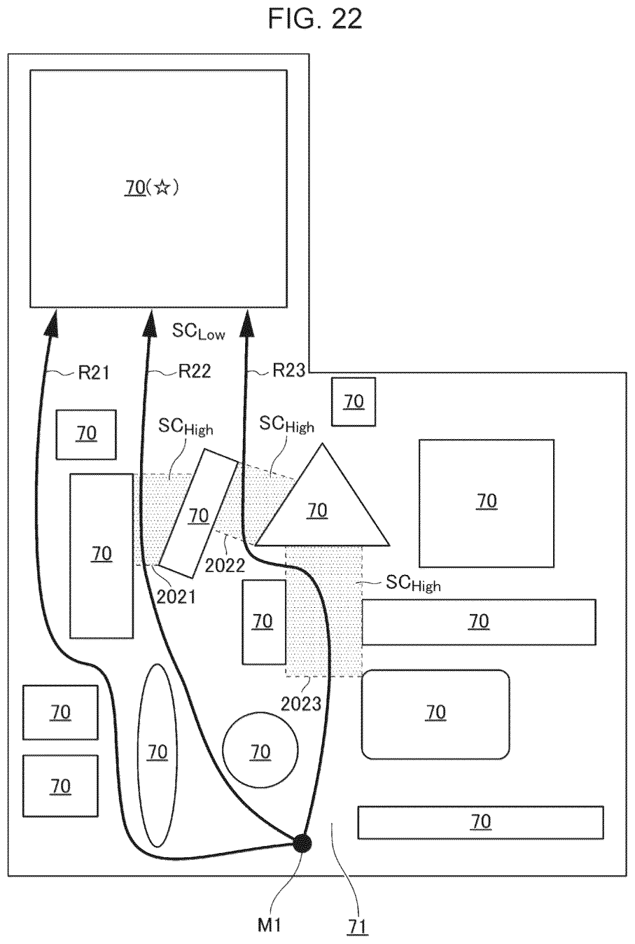

FIG. 21 is an explanatory diagram of another example of a dynamic switching method of a value of traveling cost relating to traveling region control of each avatar, and is tables showing values of traveling costs at two certain points in time (point-in-time t61 and point-in-time t62). FIG. 22 is an explanatory diagram of FIG. 21, and is an explanatory diagram of traveling costs for each traveling path of avatars.

In the example shown in FIG. 21, the value w1 of the traveling cost is associated with region IDs “0010” to “0040” at point-in-time t61, while the value w2 of the traveling cost is associated with region IDs “0010” to “0030” and the value w1 of the traveling cost is associated with region ID “0040” at point-in-time t62. The value w2 of the traveling cost will be assumed here to be significantly higher than the value w1 of the traveling cost. Accordingly, the regions 2021, 2022, and 2023 that are associated with the region IDs “0010” to “0030” are relatively easy for avatars to pass at point-in-time t61, but become difficult for avatars to pass at point-in-time t62. Note that the region ID “0040” is a nearby region of the regions 2021, 2022, and 2023.

For example, at point-in-time t62, the density of avatars (congestion degree) within the regions 2021, 2022, and 2023 increases due to an event or the like, and as a result, the regions 2021, 2022, and 2023 become difficult for avatars to pass through. For example, passing through the regions 2021, 2022, and 2023 tends to take more time because of contact among avatars (and the reactive force F or the like being generated due to the proximity/collision control among avatars accompanying such contact). In this case, avatars of which the destination is a particular space portion 70 illustrated in FIG. 22 (space portion 70 indicated by a star mark in FIG. 22) will be able to reach the destination quicker by using a travel route R21 that does not pass through the regions 2021, 2022, and 2023 (travel route R21 that passes through the region relating to region ID “0040”), rather than travel routes R22 and R23 that pass through the regions 2021, 2022, and 2023. Note that in this case, the traveling costs in cases of using the travel routes R21, R22, and R23 may be output to the avatar (user), and a guidance display may be output following the travel route that the avatar selects. Thus, dynamically changing the traveling costs in accordance with the congestion degree in each region enables travelability of avatars to be improved while reducing the possibility that the congestion degree will be unnecessarily increased. Also, the convenience of avatars can be improved by the guidance display and so forth.

Note that while a relatively high traveling cost is associated with regions in which the density (congestion degree) of avatars that can dynamically change is relatively high in FIG. 21, this is not restrictive. For example, even in regions in which the density (congestion degree) of avatars is relatively high, generation of the reactive force F by the proximity/collision control among avatars or the like does not occur in a case in which the control flag associated with this region is off, and accordingly a relatively low traveling cost may be associated therewith.

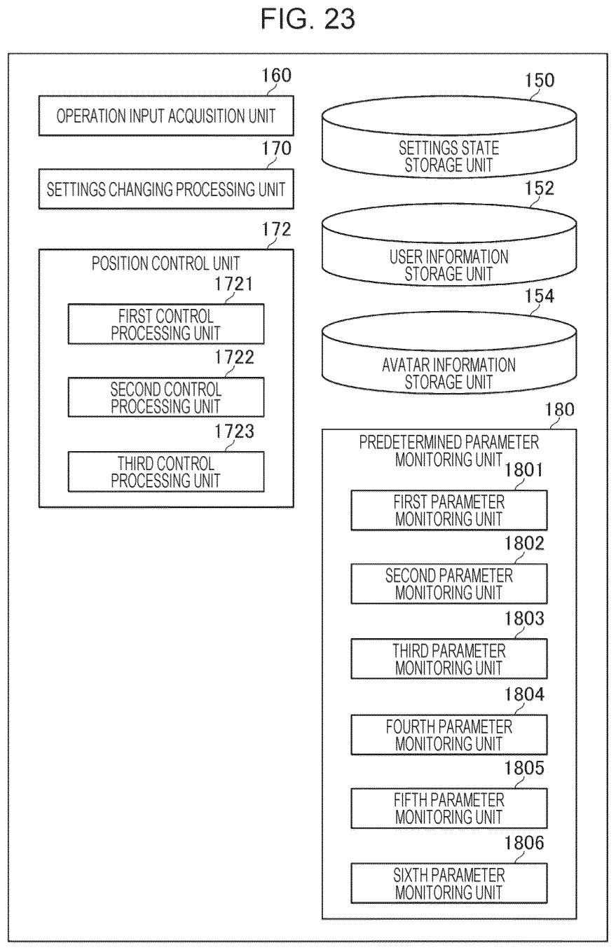

Next, specific functions and so forth of the server device 10 will be described with reference to FIG. 23 and subsequent drawings.

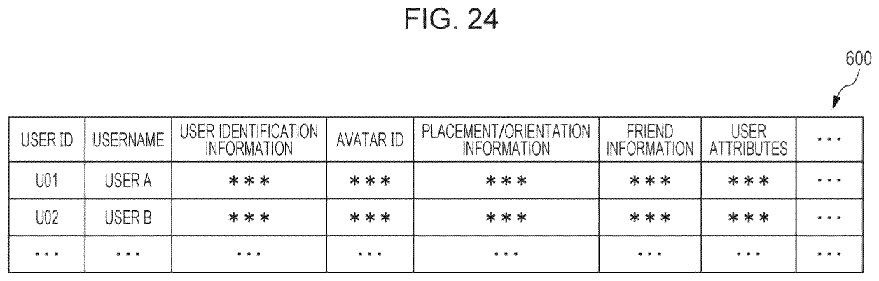

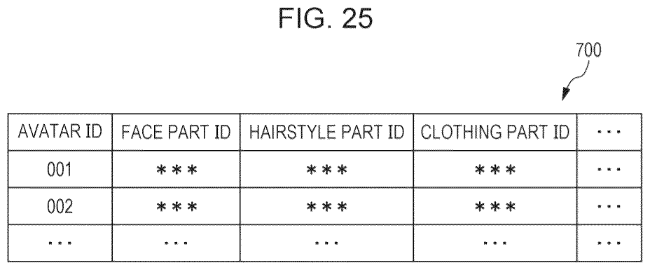

FIG. 23 is a schematic block diagram illustrating functions of the server device 10 relating to the proximity/collision control among avatars and the traveling region control described above. FIG. 24 is an explanatory diagram showing an example of data within a user information storage unit 152. FIG. 25 is an explanatory diagram showing an example of data within an avatar information storage unit 154. Note that in FIGS. 24 and 25, “***” indicates a state in which some sort of information is stored, and indicates a state in which storage of similar information is repeated. Note that part or all of the functions of the server device 10 described below may be realized by the terminal device 20 as appropriate.

The server device 10 includes a settings state storage unit 150, the user information storage unit 152, and the avatar information storage unit 154.

Each of the storage units, which are the settings state storage unit 150 to the avatar information storage unit 154, can be realized by the server storage unit 12 of the server device 10 illustrated in FIG. 1. Note that the way of dividing the storage units, which are the settings state storage unit 150 to the avatar information storage unit 154, is for the sake of convenience in description, and part or all of data stored in one storage unit may be stored in another storage unit.

The settings state storage unit 150 stores a settings state relating to the proximity/collision control among avatars, a settings state relating to the travel region control of the avatars, and a settings state relating to proximity/collision control among avatars and objects that will be described later. For example, the on/off state of the control flag that is associated with each space portion and/or each avatar, or the like, as described above, which is the on/off state of the control flag relating to the proximity/collision control among avatars, is stored. Also, the values of traveling costs that are associated with each of a plurality of regions, as described above, which are the values of traveling costs relating to the traveling region control of each avatar, are stored.

The user information storage unit 152 stores user information. In the example illustrated in FIG. 23, user information includes user information 600 relating to users.

In the user information 600, a username, user authentication information, an avatar ID, position/orientation information, friend information, user attribute information, and so forth, are associated with each user ID. The username is information that the user has registered him/herself, and may be any information. The user authentication information is information indicating that the user is an authorized user, and may include, for example, a password, an email address, date of birth, passwords, biometric information, and so forth.

The avatar ID is an ID for identifying an avatar. In the present embodiment, one avatar ID is associated with each user ID. Accordingly, in the following description, expressions such as “associated with user (or user ID)” or the like may be used interchangeably with expressions such as “associated with avatar ID” or the like. Note, however, that in other embodiments, a plurality of avatar IDs can be associated with one user ID.

The position/orientation information includes position information and orientation information of the avatar. The orientation information may be information representing the orientation of the face of the avatar. Note that the position/orientation information and so forth is information that can dynamically change in accordance with operation input by the user. In addition to the position/orientation information, information indicating movement of parts of the avatar, such as hands, feet, and so forth, facial expressions (e.g., movement of the mouth), orientation of the face or head, or direction of line of sight (e.g., direction of the eyes), objects and so forth indicating orientation or coordinates in space, such as a laser pointer, and so forth, may be included.

The friend information may include information identifying a user in a friend relation (e.g., user ID). The friend information may be used as a parameter representing a degree of friendship among avatars (among users), which will be described later.

The user attribute information represents attributes of a user or avatar (hereinafter referred to simply as “user attributes”). The user attributes may include particular users such as operator-side users, host users that perform distribution activities and so forth, celebrities and influencers (users that have a markedly greater number of follow requests as compared to other users in the virtual space, etc.), and so forth, nuisance users that have been warned or reported by other users, general users, and so forth. Now, general users may include users managing or owning a space portion 70 in a certain section, i.e., users that edit and make public a certain section within the virtual space, and for example, a user that provides an event venue may be imparted with a user attribute of which the attribute differs from particular users that appear therein. Note that the user attributes may be automatically imparted on the basis of activities and so forth of the avatars in the virtual space, or may be linked with attributes in reality. Also, user attributes may be shared through files, databases, application programming interface (API) requests, NFTs, and so forth, among different platforms, or may be converted and shared as attributes described in other systems or NFTs, or attributes within this system based on external appearance features of the avatars (color of skin, etc.).

Avatar information relating to avatars is stored in the avatar information storage unit 154.

In the example shown in FIG. 25, avatar information 700 has a face part ID, a hairstyle part ID, a clothing part ID, and so forth, associated with each avatar ID. Parts information relating to appearance, such as the face part ID, the hairstyle part ID, the clothing part ID and so forth, are parameters characterizing the avatars, and may be selected by the respective users. For example, a plurality of pieces of information relating to appearance of the avatars, such as the face part ID, the hairstyle part ID, the clothing part ID, and so forth, are prepared. Also, part IDs for each of various parts such as the shape of the face, eyes, mouth, nose, and so forth may be prepared for the face part ID, and the information relating to the face part ID may be a combination of the IDs of each of the parts making up the face that is managed. In this case, the avatars can be drawn not only at the server device 10 but also at the terminal device 20 side, on the basis of each ID relating to appearance associated with each avatar ID.

Also, the server device 10 includes an operation input acquisition unit 160, a settings changing processing unit 170, a position control unit 172, and a predetermined parameter monitoring unit 180. The operation input acquisition unit 160 through the predetermined parameter monitoring unit 180 can be realized by the server control unit 13 illustrated in FIG. 1. Also, part of the operation input acquisition unit 160 through the predetermined parameter monitoring unit 180 (functional part that performs communication with the terminal device 20) can be realized by the server communication unit 11 along with the server control unit 13 illustrated in FIG. 1.

The operation input acquisition unit 160 acquires, from the terminal device 20, operation input information generated in accordance with various types of operations performed by the user. Note that the operation input information from the user is generated via the input unit 24 of the terminal device 20 described above. Note that the operation input information may include operation input for changing the position of the avatar in virtual space (traveling operation input), operation input for changing values of other parameters such as the orientation and so forth of the avatar (parameters other than traveling), operation input generated via a user interface, speech or text input performed for conversation or the like, and so forth. Note that traveling operation input may be generated by operation of particular keys (e.g., “WASD” keys), generated via a user interface including arrow buttons or the like, or generated by speech or movement such as gestures or the like.

The settings changing processing unit 170 dynamically changes the setting values of the control flag described above, the values of the traveling cost described above, and setting values of an editing flag that will be described later, on the basis of monitoring results of various types of parameters by a predetermined parameter monitoring unit 180 that will be described later. The settings changing processing unit 170 may dynamically change the setting values of the control flag (on/off state), the values of the traveling cost, and/or the setting values of the editing flag, by updating (dynamically changing) data in the settings state storage unit 150. Further details of the settings changing processing unit 170 will be described later in relation to description of the predetermined parameter monitoring unit 180 described later.

The position control unit 172 controls positions, orientations, and so forth, of the plurality of avatars in the virtual space, on the basis of operation input (travel operation input) and so forth that is acquired by the operation input acquisition unit 160. At this time, the position control unit 172 controls the positions, orientations, and so forth, of the plurality of avatars in the virtual space, on the basis of the data in the settings state storage unit 150 (on/off state of the control flag and values of the traveling cost).

Now, controlling the position of an avatar is a concept including not only a form of controlling the position (coordinates) of the overall avatar, but also including a form of controlling positions of each part of the avatar, and may include, in addition thereto or instead thereof, a form of controlling positions and states of clothing of the avatar and/or nearby phenomena. In the same way, controlling the orientation of the avatar is a concept including not only a form of controlling the orientation of the overall avatar, but also including a form of controlling orientations of each part of the avatar, and may include, in addition thereto or instead thereof, a form of controlling orientations of clothing of the avatar and/or nearby phenomena. Any granularity may be used for the granularity of each part of the avatar, and the parts themselves of the avatar may be parts defined by a skeletal frame model in which objects such as, for example, hands, feet, fingers, wings, tails, and so forth are set. Control of the positions and orientations of each part relating to the avatar itself can be defined by the skeletal frame model in both cases of human-type avatars (humanoid avatars) and cases of non-human-type avatars (animal-type avatars, furry-type avatars, etc.), but in a case of expressing distances or repelling force to other avatars by clothing and equipment of the avatar, or by phenomena nearby the avatar, physical simulation may be performed regarding accessories that are worn, equipment such as weapons, objects that a flexible such as clothes and hair, and so forth, for example, so as to include the results thereof. Phenomena nearby the avatar may include phenomena such as “wearing the wind”, “wearing an aura”, “throwing up a barrier”, and so forth, which are uncontrollable or nonexistent in the real world but can be expressed as interactive visual expressions. As a result of the position control unit 172 controlling the position of the avatar including such points as described above, there can be cases in which the positions of particular parts of the avatar, clothing, and/or nearby phenomenon change, while the position (coordinates) of the overall avatar remains unchanged.

The position control unit 172 includes a first control processing unit 1721, a second control processing unit 1722, and a third control processing unit 1723.

The first control processing unit 1721 executes the proximity/collision control among avatars on the basis of setting values (on/off state) of the control flag described above. For example, when the control flag associated with one space portion 70 is on, the first control processing unit 1721 executes the proximity/collision control among avatars within the one space portion 70. On the other hand, when the control flag associated with one space portion 70 is off, the first control processing unit 1721 does not execute the proximity/collision control among avatars within the one space portion 70. In the same way, when the control flag associated with one avatar is on, the first control processing unit 1721 executes the proximity/collision control among avatars regarding the one avatar. On the other hand, when the control flag associated with one avatar is off, the first control processing unit 1721 does not execute the proximity/collision control among avatars regarding the one avatar. Note that the same may substantially apply in cases in which setting values of the control flag are associated with correlations among avatars, as described above.

At the time of executing the proximity/collision control among avatars, the first control processing unit 1721 may execute determination processing relating to proximation distance or collision among the plurality of avatars, and averting processing so that no proximation distance or collision occurs among the avatars, on the basis of results of the determination processing. The first control processing unit 1721 may also, instead of or in addition to the averting processing, execute animation processing of automatically drawing behavior of each avatar at the time of collision or proximation distance between avatars being less than a threshold.

Specifically, the first control processing unit 1721 first determines whether or not the distance among avatars is smaller than the predetermined distance L₀, as the determination processing. With respect to one object avatar, other avatars that are the objects of monitoring distance among avatars may be all avatars that are at positions nearby the one object avatar, or may be part of the avatars. For example, with respect to one object avatar, other avatars that are the objects of monitoring distance among avatars may be avatars positioned within a circular region with a predetermined radius L1, with the position of the one object avatar as a reference. In this case, the predetermined radius L1 is significantly larger than the predetermined distance L₀. Note that regions of other forms may be used instead of the circular region. Appropriately setting the predetermined radius L1 enables the number of other avatars that are the object of monitoring distance among avatars to be efficiently reduced, and the processing load can be reduced.

In a case in which the distance among avatars is smaller than the predetermined distance L₀, on the basis of the results of the determination processing, the first control processing unit 1721 then executes the averting processing so that the distance among avatars will become greater. The averting processing may include processing of generating the reactive force F or the like, as described above with reference to FIG. 6.

The second control processing unit 1722 executes the travel region control of each avatar, on the basis of the values of traveling cost described above. Specifically, the second control processing unit 1722 sets regions associated with a relatively high traveling cost value (e.g., value w2 described above with reference to FIG. 18) as regions through which avatars cannot pass, or passage thereof is difficult (hereinafter, these will be also referred to as “traveling-prohibited regions” without distinguishing therebetween).

At the time of executing the travel region control of each avatar, the second control processing unit 1722 may execute determination processing for determining the positional relations between each avatar and a traveling-prohibited region, and averting processing so that traveling to the traveling-prohibited region does not occur, on the basis of the results of the determination processing. The second control processing unit 1722 may also, instead of or in addition to the averting processing, execute animation processing of automatically drawing behavior of avatars traveling through the traveling-prohibited region.

Specifically, the second control processing unit 1722 first determines whether or not the distance between each avatar and the traveling-prohibited region is no greater than a predetermined distance L2, as the determination processing. The predetermined distance L₂ may be a value that is zero or a small value close to zero.

Thereafter, in a case in which the distance between one avatar and the traveling-prohibited region is found to be no greater than the predetermined distance L₂ on the basis of the results of the determination processing, the second control processing unit 1722 executes averting processing such that the distance between the one avatar and the traveling-prohibited region will become greater. The averting processing may include processing of generating the reactive force F or the like, in the same way as in the case of the proximity/collision control among avatars.

Alternatively, the second control processing unit 1722 may execute processing to reduce the speed of travel of an avatar positioned within the traveling-prohibited region. That is to say, the second control processing unit 1722 may execute processing such that the avatar positioned within the traveling-prohibited region is imparted with resistance when attempting to travel. In this case, the resistance that the avatar is imparted with may change in accordance with attributes of the traveling-prohibited region. For example, in a case in which the traveling-prohibited region is a region that has water, such as a “swimming pool”, resistance such as when walking through water may be imparted.

The third control processing unit 1723 executes proximity/collision control among avatars and objects other than avatars (hereinafter also referred to as “proximity/collision control among avatars and objects”), on the basis of the setting value (on/off state) of the editing flag (another example of first control parameter). The editing flag will be on, in a case of an input mode for constructing or editing the virtual space (e.g., various types of objects within a space portion 70). The input mode for constructing or editing the virtual space (hereinafter also referred to as “editing mode”) refers to a mode in which objects (hereinafter also referred to as “predetermined objects”) corresponding to any virtual reality mediums that are different from avatars (e.g., buildings, walls, trees, NPCs, and so forth) are placed in the virtual space. For example, a user who manages or owns a space portion 70 in a certain section can place various types of predetermined objects in the space portion 70 by forming the editing mode. Note that editing flags may be associated with positions in the virtual space according to any form, such as being associated with each space portion 70 or with each region, and so forth.

At the time of executing the proximity/collision control among avatars and objects, the third control processing unit 1723 may execute determination processing of determining the positional relation between each avatar and a predetermined object, and averting processing so that proximation distance being less than a threshold or collision between the avatars and the predetermined object does not occur, on the basis of results of the determination processing. The third control processing unit 1723 may also, instead of or in addition to the averting processing, execute animation processing of automatically drawing behavior of each of the avatar and the predetermined object at the time of collision or proximation distance being less than a threshold.

Specifically, the third control processing unit 1723 first determines whether or not the distance between the avatar and the predetermined object is no greater than a predetermined distance L₃, as the determination processing. The predetermined distance L₃ may be a value that is zero or a small value close to zero.

Thereafter, in a case in which the distance between the avatar and the predetermined object is no greater than the predetermined distance L₃ on the basis of the results of the determination processing, the third control processing unit 1723 executes the averting processing such that the distance between the avatar and the predetermined object will become greater. The averting processing may include processing of generating the reactive force F or the like, in the same way as with the proximity/collision control among avatars.

Note that the third control processing unit 1723 may operate on the basis of the setting value (on/off state) of the control flag associated with a position such as a space portion 70 or the like, instead of or in addition to the setting value (on/off state) of the editing flag (another example of first control parameter). In this case, when the control flag associated with one space portion 70 is in the on state, for example, the third control processing unit 1723 may be on with regard to a predetermined object placed within the one space portion 70, and when this control flag is in the off state, the third control processing unit 1723 may be off with regard to a predetermined object placed within the one space portion 70.

The predetermined parameter monitoring unit 180 calculates values of various types of predetermined parameters that can be calculated with regard to the virtual space. Monitoring results of the values of the various types of parameters are used by the settings changing processing unit 170 described above. That is to say, the settings changing processing unit 170 dynamically changes the setting value (on/off state) of the control flag, the value of the traveling cost, and the setting value (on/off state) of the editing flag, on the basis of the results of monitoring the values of the various types of predetermined parameters.

The predetermined parameter monitoring unit 180 includes a first parameter monitoring unit 1801 to a sixth parameter monitoring unit 1806.

The first parameter monitoring unit 1801 monitors a value of a first parameter that represents or suggests a processing load for information processing regarding the virtual space. The first parameter may be an index value that represents or suggests the processing load of the server device 10 for example, and this index value may be as described above.

In this case, the control form relating to the proximity/collision control among avatars can be dynamically changed in accordance with the processing load for information processing. For example, in a case in which the processing load of the server device 10 is no less than the threshold value load, the settings changing processing unit 170 may change the control flag to the off state such that the first control processing unit 1721 does not function. Accordingly, increase in the processing load due to the first control processing unit 1721 functioning can be prevented in a situation in which the processing load of the server device 10 is no less than the threshold value load.

Note that the settings changing processing unit 170 may set all control flags to off in a case in which the processing load of the server device 10 is no less than the threshold value load, or may set just a part of the control flags to off. For example, in a case in which a setting value of a control flag is associated with each of the plurality of space portions 70, the settings changing processing unit 170 may set the control flags to off in order from space portions 70 of which the degree of influence on the processing load of the server device 10 is highest (e.g., space portions 70 with a great number of avatars). Alternatively, the settings changing processing unit 170 may set the control flags to off stepwise, as the processing load of the server device 10 increases. For example, the settings changing processing unit 170 may increase the number of the space portions 70 regarding which the control flag is set to off in a stepwise manner, as the processing load of the server device 10 increases. These examples can be applied in the same way regarding cases in which the control flags are associated with respective avatars (see FIGS. 10 and 11, etc.), and cases of being associated with correlations among avatars (see FIG. 12), as described above.

Also, in another embodiment, the settings changing processing unit 170 may dynamically change the value of the traveling cost in accordance with the processing load of information processing. In this case, the control form relating to traveling region control of each avatar can be dynamically changed in accordance with the processing load of information processing. For example, in a case in which the processing load of the server device 10 is no less than the threshold value load, the settings changing processing unit 170 may change the value of the traveling cost associated with each position or a particular position to a relatively low value (e.g., the value w1 described above). In this case, the regions in which each avatar is capable of traveling in the virtual space are broader, and accordingly the distances among avatars becomes broader more readily, and as a result, reduction in the processing load relating to the proximity/collision control among avatars can be expected.

A second parameter monitoring unit 1802 monitors a value of a second parameter that represents or suggests a degree of friendship among a plurality of avatars. The degree of friendship among the plurality of avatars may be basically evaluated on a one-on-one relation. For example, the degree of friendship between one avatar and another one avatar may be deemed as being the same as the degree of friendship between corresponding users. The degree of friendship between users may be calculated on the basis of user information (e.g., friend information) in the user information storage unit 152, such as described above with reference to FIG. 24.

In this case, the control form relating to the proximity/collision control among avatars can be dynamically changed in accordance with the degree of friendship between the avatars. For example, the settings changing processing unit 170 may change the control flag to the off state for a correlation between avatars of which the degree of friendship is no less than a threshold value degree of friendship (example of second predetermined threshold value), so that the first control processing unit 1721 does not function. In this case, in a configuration in which the control flags are associated with the respective avatars such as described above (see FIGS. 10 and 11, etc.), in a case in which avatars of which the degree of friendship is no less than the threshold value degree of friendship are positioned within the predetermined radius L1 from each other, the control flags associated with these avatars may be set to off. On the other hand, in a configuration in which control flags are associated with correlations among avatars (see FIG. 12), the control flags associated with correlations among avatars may be set to off when the degree of friendship is no less than the threshold value degree of friendship.

A third parameter monitoring unit 1803 monitors a value of a third parameter that represents or suggests an attribute of each avatar. The attribute of an avatar may be the same as the attribute of the corresponding user, or may be different. For example, the value of the third parameter may include a value in which the user attribute represents one of operator-side users, distributing users, particular users (users who are celebrities, influencers, etc.), nuisance users, and general users. For example, the value of the third parameter may include a value indicating whether or not the user attribute thereof is a general user. Now, general users may include users managing or owning a space portion 70 in a certain section, i.e., users that edit and make public a certain section within the virtual space, and for example, a user that provides an event venue may be imparted with a user attribute of which the attribute differs from particular users that appear in the event venue.

In this case, the control form relating to the proximity/collision control among avatars can be dynamically changed in accordance with the attribute of each avatar. For example, in a case of one avatar having a user attribute (example of predetermined attribute) other than that of a general user for example, the settings changing processing unit 170 may change the control flag to the on state such that the first control processing unit 1721 functions with respect to the one avatar. Thus, the possibility of a great number of avatars flocking to an avatar such as a celebrity, influencer, or the like, resulting in disorder, can be reduced. Separately, an avatar of a nuisance user can be prevented from harassing other avatars. Note that in this case, the predetermined distance L₀ relating to the avatar of a celebrity, influencer, or the like may be set to be an appropriate size that is relatively large, or a region within a predetermined radius L2 centered on the position of the avatar of the celebrity, influencer, or the like may be associated with a value of traveling cost that is extremely high. Conversely, in a case in which one avatar has a user attribute of a general user (other example of predetermined attribute), the settings changing processing unit 170 may change the control flag to the off state such that the first control processing unit 1721 does not function regarding the one avatar.

A fourth parameter monitoring unit 1804 monitors a value of a fourth parameter that represents or suggests an action attribute or a motion mode of each avatar. For example, the value of the fourth parameter may include a value representing whether or not the action attribute or the motion mode of the avatar relates to actions or motions of a plurality of avatars for a group event. The action attribute or the motion mode of the avatar may be estimated (predicted) by artificial intelligence or the like, or may be set on the basis of user input (e.g., operation of a selection button for the motion mode, etc.). A group event is an event in which there is a possibility of a plurality of avatars coming close to each other, and any form, name, and so forth thereof can be used. A group event may include the event relating to the commemorative photograph, described above with reference to FIG. 15, for example.

In this case, the control form relating to the proximity/collision control among avatars can be dynamically changed in accordance with the action attribute or the motion mode of an avatar. For example, in a case in which the action attribute or the motion mode of the avatar is an action attribute or a motion mode relating to actions or motions of a plurality of avatars for a group event, the settings changing processing unit 170 may change the control flag to the off state, so that the first control processing unit 1721 does not function. Thus, inconvenience due to the proximity/collision control among avatars being executed in a group event in which there is a possibility of a plurality of avatars coming near to each other (e.g., a situation in which the reactive force F acts and the avatars cannot congregate close to each other) can be prevented.

A fifth parameter monitoring unit 1805 monitors a value of a fifth parameter that represents or suggests avatar density in a particular region. The avatar density in the particular region may be a value obtained by dividing the headcount of avatars positioned in the particular region by the area (size) of the particular region. The particular region can be any region, but may be a popular spot, event venue, or the like, at which the avatar density tends to be high.

In this case, the control form relating to the proximity/collision control among avatars can be dynamically changed in the particular region, in accordance with the avatar density in the particular region. For example, in a case in which the avatar density in the particular region is no less than a threshold value density (example of third predetermined threshold value), the settings changing processing unit 170 may change the control flag to the on state such that the first control processing unit 1721 functions. On the other hand, in a case in which the avatar density in the particular region is lower than the threshold value density, the settings changing processing unit 170 may change the control flag to the off state such that the first control processing unit 1721 does not function. Thus, the avatar density in the particular region can be prevented from becoming excessively great.

The sixth parameter monitoring unit 1806 monitors a value of a sixth parameter that represents or suggests an input mode of the user associated with the avatar. The value of the sixth parameter may include a value representing that the input mode of the user is the above-described editing mode.

In this case, the control form relating to the proximity/collision control among avatars and objects can be dynamically changed in accordance with the input mode of the user. For example, in a case in which the input mode of the user is the editing mode, the settings changing processing unit 170 may change the corresponding flag (hereinafter also referred to as “control flag for control among avatars and objects”) to the off state, such that the proximity/collision control among avatars and objects is off. Accordingly, inconveniences that can occur due to the proximity/collision control among avatars and objects being executed in a case in which the input mode is the editing mode (e.g., inconveniences such as attempting to touch a predetermined object to change the placement thereof but not being able to do due to reactive force F or the like) can be reduced. Note that in this case, the control flag for control among avatars and objects may be associated with positions, such as for each space portion 70 or each region. Accordingly, in a case in which the editing mode is being carried out with respect to one particular space portion 70, the proximity/collision control among avatars and objects may be set to off just for the one particular space portion 70.

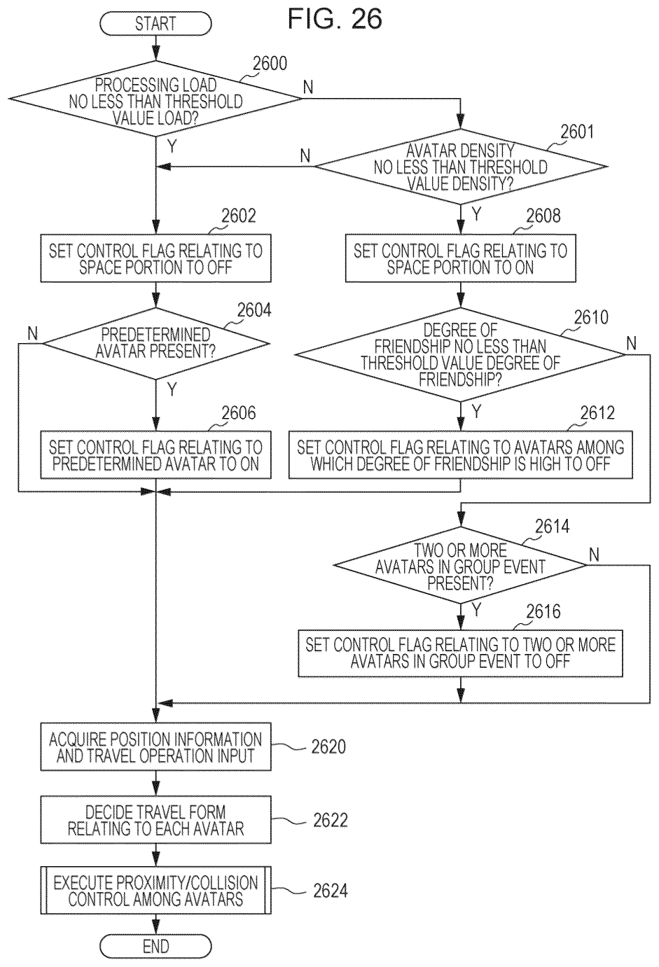

Next, an operation example of the virtual reality generating system 1 relating to the proximity/collision control among avatars, the traveling region control of the avatars, and so forth will be described with reference to FIG. 26 and thereafter.

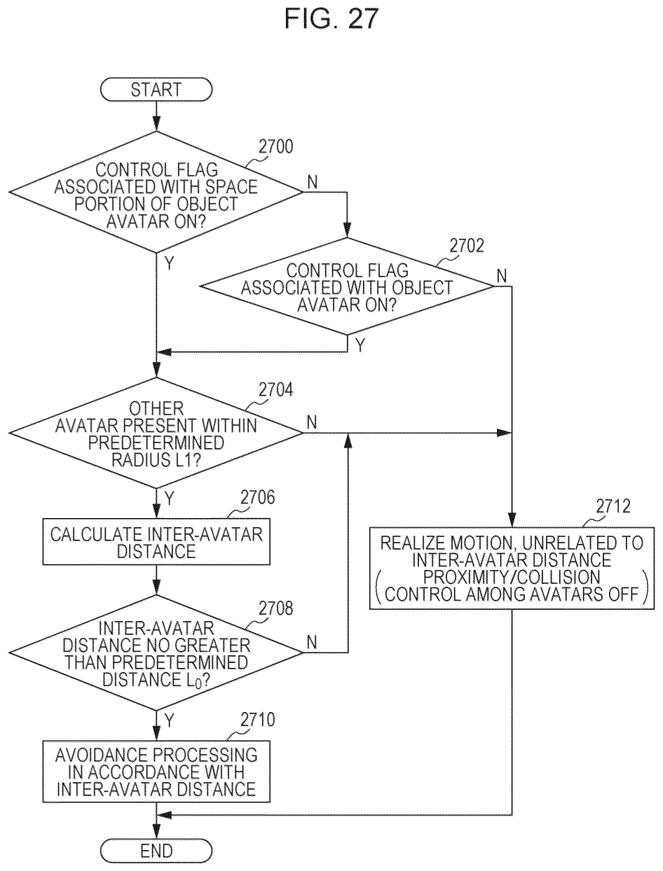

FIG. 26 is a flowchart showing an example of processing that may be executed by the server device 10 with relation to the proximity/collision control among avatars. The processing shown in FIG. 26 may be executed independently at each space portion 70. In the description of FIG. 26 below (and the later-described FIG. 27 as well), the term “space portion 70” refers to one space portion 70 that is the object of the description.

In step S2600, the server device 10 determines whether or not the processing load of the server device 10 is no less than the threshold value load. In a case in which the determination result is “YES”, the flow advances to step S2602, and otherwise, the flow advances to step S2601.

In step S2601, the server device 10 determines whether or not the avatar density in the space portion 70 is no less than a threshold value density. In a case in which the determination result is “YES”, the flow advances to step S2608, and otherwise, the flow advances to step S2602.

In step S2602, the server device 10 sets the control flag associated with the space portion 70 to the off state.

In step S2604, the server device 10 determines whether or not an avatar having a user attribute other than a general user (hereinafter also referred to as “predetermined avatar”) is present in the space portion 70. In a case in which the determination result is “YES”, the flow advances to step S2606, and otherwise, the flow advances to step S2620.

In step S2606, the server device 10 sets the control flag associated with the predetermined avatar to the on state. For example, in a case in which a particular event is to be held in the space portion 70, the avatar of a distributing user who will be participating in the particular event as a distributer may be treated as a predetermined avatar, and the control flag that is associated with this avatar may be set to the on state. Accordingly, in this case, the proximity/collision control among avatars is basically not executed in the space portion 70, but the proximity/collision control among avatars can be executed with regard to the predetermined avatar. Note that this distributing user may be handled as a general user in other space portions 70. Thus, in a case in which user attributes dynamically change, the setting value (on/off state) of the control flag may be dynamically changed in accordance with this dynamic change.

As for other triggers for setting the control flag associated with the predetermined avatar to the on state, whether or not the avatar is a paying avatar may be taken into consideration. For example, an arrangement may be made in which a user who pays a user on the operator side in the real world is given special treatment, a user who pays with virtual currency in virtual space is given special treatment, and so forth. Examples of special treatment may include setting the control flag for this predetermined avatar to the on state at all times in all locations, or setting the control flag thereof to the on state at a predetermined date-and-time and location, and so forth. Note that in order to prevent virtual space from being created in which users on an administrator side and users who edit and make public certain sections in the virtual space cannot travel, the control flag of such users may be set to the off state at all times or as necessary, so as to be capable of freely traveling without colliding with the ground, walls, ceilings, and so forth in the virtual space. Also, the control flag is set to the off state between avatars of which the degree of friendship is no less than the threshold value degree of friendship, which will be described later, and in a case in which a user issues a “right to sit in this couple's seat”, or the like, as a user-generated content (UGC) for example, the control flag may be set to the off state for users paying for this right as a paid item, so as to have a right or a mode such as “other-user collision off”. Note that in a case in which a general user sets up a UGC, an arrangement may be made in which the profits can be distributed between the creator of the UGC and another user. For example, a special paid seat, such as a “throne” or a “VIP seat” may be created, with 50% of the sales being distributed to a platformer (PF) who is an operator-side user, and 50% to the creator of the UGC.

In step S2608, the server device 10 sets the control flag that is associated with the space portion 70 to the on state.

In step S2610, the server device 10 determines whether or not an avatar of which the degree of friendship is no less than the threshold value degree of friendship is present. In a case in which the determination result is “YES”, the flow advances to step S2612, and otherwise, the flow advances to step S2614.

In step S2612, the server device 10 sets the control flag associated with avatars of which the degree of friendship is no less than the threshold value degree of friendship (described as “AVATARS AMONG WHICH DEGREE OF FRIENDSHIP IS HIGH” in FIG. 26) to the off state.

In step S2614, the server device 10 determines whether or not two or more avatars of which the action attribute or the motion mode relates to an action or a motion for a group event are present in the space portion 70 (described as “TWO OR MORE AVATARS IN GROUP EVENT” in FIG. 26). In a case in which the determination result is “YES”, the flow advances to step S2616, and otherwise, the flow advances to step S2620.

In step S2616, the server device 10 sets, with respect to the two or more avatars of which the action attribute or the motion mode relates to the action or the motion for the group event, the control flag associated therewith respectively to the off state.

In step S2620, the server device 10 acquires position information of each avatar in the space portion 70, and travel operation input from each user relating to each avatar.

In step S2622, the server device 10 decides the travel form relating to each avatar, on the basis of the position information and the travel operation input obtained in step S2620, and the values of travel cost associated with each position in the space portion 70. Note that while dynamic change of the values of travel cost is not described in FIG. 26, the values of travel cost used in step S2622 may be dynamically changeable, as described above.

In step S2624, the server device 10 executes the proximity/collision control among avatars on the basis of setting states of each control flag related to the space portion 70 and/or each avatar in the space portion 70, and the travel form related to each avatar that is decided in step S2622.

Thus, according to the processing shown in FIG. 26, the control flags can be dynamically changed in various forms on the basis of values of various types of predetermined parameters, such as the processing load of the server device 10, avatar density, and so forth.

Note that in the processing shown in FIG. 26, an example is described of setting the control flag associated with the space portion 70 to on in a case in which the avatar density in the space portion 70 is no less than the threshold value density, to avoid overcrowding. However, the control flag associated with the space portion 70 may be conversely set to the off state in a case in which the avatar density in the space portion 70 is no less than the threshold value density, in order to reduce the processing load.

Also, in the processing shown in FIG. 26, an example is described of the server device 10 setting the control flag associated with a predetermined avatar to the on state in step S2606, so that other avatars do not come too close to the predetermined avatar. However, in another example, the server device 10 may set the control flag associated with the space portion 70 to the on state, for the same purpose.

FIG. 27 is a schematic flowchart showing an example of the proximity/collision control among avatars that is executed in step S2624 in FIG. 26. The processing shown in FIG. 27 may be executed with respect to one object avatar, and similar processing may be executed in parallel regarding other avatars.

In step S2700, the server device 10 determines whether or not the control flag that is associated with the space portion 70 in which the object avatar is present is in the on state. In a case in which the determination result is “YES”, the flow advances to step S2704, and otherwise, the flow advances to step S2702.

In step S2702, the server device 10 determines whether or not the control flag associated with the object user is in the on state. In a case in which the determination result is “YES”, the flow advances to step S2704, and otherwise, the flow advances to step S2712.

In step S2704, the server device 10 determines whether or not another avatar is present within the predetermined radius L1 with the position of the object avatar as the center thereof. In a case in which the determination result is “YES”, the flow advances to step S2706, and otherwise, the flow advances to step S2712.

In step S2706, the server device 10 calculates the distance between the other avatar of which the presence has been determined in step S2704 and the object avatar (herein also referred to simply as “inter-avatar distance”). Note that in a case in which a plurality of other avatars are present, the distances between each of the other avatars and the object avatar (inter-avatar distances) are calculated.

In step S2708, the server device 10 determines whether or not the inter-avatar distance calculated in step S2706 is no greater than the predetermined distance Lo. In a case in which the determination result is “YES”, the flow advances to step S2710, and otherwise, the flow advances to step S2712.

In step S2710, the server device 10 executes the above-described averting processing in accordance with the inter-avatar distance between the other avatar and the object avatar (≤predetermined distance L₀). For example, the server device 10 may correct the travel form relating to each avatar decided in step S2622 in FIG. 26 and execute the above-described averting processing.

In step S2712, the server device 10 realizes the movement of the object avatar without executing the proximity/collision control among avatars with respect to the object avatar. That is to say, the server device 10 may realize the traveling form relating to each avatar decided in step S2622 in FIG. 26 without change. In this case, calculation processing of the inter-avatar distance (step S2706), determination processing (step S2708), and averting processing (step S2710) become unnecessary, and processing efficiency can be raised.

Thus, according to the processing shown in FIG. 27, the proximity/collision control among avatars relating to each avatar can be efficiently realized in accordance with the setting value (on/off state) of the control flag.

Note that while the processing shown in FIG. 27 does not take into consideration control flags that can be associated with correlations among avatars, this can also be taken into consideration. In this case, the inter-avatar distance may be calculated for each correlation among avatars associated with the control flag in the on state, and similar averting processing may be executed in a case in which the inter-avatar distance is no greater than the predetermined distance L₀.

Also, in the example shown in FIG. 27, although the number of other avatars that are the object of calculation of the inter-avatar distance is reduced by extracting other avatars within the predetermined radius L1, as described above with reference to steps S2704 and S2706, this processing may be omitted.

Although description of FIGS. 26 and 27 has been made with regard to a case of the processing of each step being executed by the server device 10, the virtual reality generating system 1 (information processing system) according to the present embodiment may be realized by the server device 10 alone, or may be realized by the server device 10 and one or more terminal devices 20 in collaborative operation, as described earlier. In the case of the latter, an arrangement may be made in which, for example, various types of parameters of another avatar nearby the avatar that is present in the space portion 70 being drawn are transmitted from the server device 10 to the terminal devices 20, the processing of the proximity/collision control is executed at the terminal devices 20 using the various types of parameters that are received (step S2624), and the other avatar is drawn on the basis of each of the above-described IDs relating to appearance that are associated with each of the avatar IDs. In a case of performing drawing at the terminal device 20 side, each of the objects, relations with each of the objects, and so forth, do not necessarily have to be drawn in the same way at each of the terminal devices 20. That is to say, depending on settings performed by one user, drawn contents at the terminal device 20 of just that one user may be different from those at other terminal devices 20. For example, settings may be made such that the avatar relating to the one user is not capable of slipping through a certain object, but such that other avatars are capable of slipping through.

Although embodiments have been described in detail, the present disclosure is not limited to specific embodiments, and various modifications and alterations can be made within the scope of the Claims. Also, all or a plurality of the components of the embodiment described above can be combined.

For example, in the above description, with regard to the proximity/collision control among avatars, not only is a form disclosed in which the control flag is set to on or off, but also a point is disclosed in which the predetermined distance L₀ is increased while maintaining the control flag in the on state, whereby the processing load relating to the proximity/collision control among avatars (and accordingly the processing load of the server device 10) can be reduced in a stepwise manner. However, instead of or in addition to increasing or reducing the predetermined distance L₀ while maintaining the control flag in the on state, other setting values of control parameters can be dynamically changed, thereby dynamically changing the processing load relating to the proximity/collision control among avatars (and accordingly the processing load of the server device 10). In this case, the other control parameters may include the above-described predetermined radius L1. Also, the other control parameters may include a parameter for setting the calculation method regarding inter-avatar distances. Specifically, the calculation method regarding inter-avatar distances can be a first calculation method in which distances among representative positions such as the center of each avatar are calculated, and a second calculation method in which shortest distances among virtual capsules covering each avatar are calculated, such as described above. In the second calculation method, there is a method in which just one virtual capsule is set for one avatar, a method in which virtual capsules are set for each part, and so forth. In this case, dynamically changing these calculation methods can dynamically change the processing load relating to proximity/collision control among avatars (and accordingly the processing load of the server device 10).

Also, although data in the settings state storage unit 150 such as on/off state of control flags, values of traveling cost, and so forth, are automatically realized by the server device 10 executing a program in the above-described embodiment, part or all of data in the settings state storage unit 150 may be dynamically set (changed) on the basis of input from users (e.g., users on the operator side and general users).

FIG. 28 is a block diagram of processing circuitry that performs computer-based operations in accordance with the present disclosure. FIG. 28 illustrates processing circuitry 300 which may be a component of server 10 and/or terminal device 20.

Processing circuitry 300 is used to control any computer-based and cloud-based control processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The functionality of the elements disclosed herein may be implemented using circuitry or processing circuitry which may include general purpose processors, special purpose processors, integrated circuits, ASICs (“Application Specific Integrated Circuits”), conventional circuitry and/or combinations thereof which are configured or programmed to perform the disclosed functionality. Processors are processing circuitry or circuitry as they include transistors and other circuitry therein. The processor may be a programmed processor which executes a program stored in a memory. In the disclosure, the processing circuitry, units, or means are hardware that carry out or are programmed to perform the recited functionality. The hardware may be any hardware disclosed herein or otherwise known which is programmed or configured to carry out the recited functionality.

In FIG. 28, the processing circuitry 300 includes a CPU 301 which performs one or more of the control processes discussed in this disclosure. The process data and instructions may be stored in memory 302. These processes and instructions may also be stored on a storage medium disk 304 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other non-transitory computer readable medium of an information processing device with which the processing circuitry 300 communicates, such as a server or computer. The processes may also be stored in network based storage, cloud-based storage or other mobile accessible storage and executable by processing circuitry 300.

Further, the claimed advancements may be provided as a utility application, background daemon, or component of an operating system, or combination thereof, executing in conjunction with CPU 301 and an operating system such as Microsoft Windows, UNIX, Solaris, LINUX, Apple MAC-OS, Apple iOS and other systems known to those skilled in the art.

The hardware elements in order to achieve the processing circuitry 300 may be realized by various circuitry elements. Further, each of the functions of the above described embodiments may be implemented by circuitry, which includes one or more processing circuits. A processing circuit includes a particularly programmed processor, for example, processor (CPU) 301, as shown in FIG. 28. A processing circuit also includes devices such as an application specific integrated circuit (ASIC) and conventional circuit components arranged to perform the recited functions.

In FIG. 28, the processing circuitry 300 may be a computer or a particular, special-purpose machine. Processing circuitry 300 is programmed to execute processing of server control unit 13 of server device 10. In other embodiments, processing circuitry 300 is programmed to execute processing of terminal control unit 25 of terminal device 20.

Alternatively, or additionally, the CPU 301 may be implemented on an FPGA, ASIC, PLD or using discrete logic circuits, as one of ordinary skill in the art would recognize. Further, CPU 301 may be implemented as multiple processors cooperatively working in parallel to perform the instructions of the inventive processes described above.

The processing circuitry 300 in FIG. 28 also includes a network controller 306, such as an Ethernet PRO network interface card, for interfacing with network 550. As can be appreciated, the network 550 can be a public network, such as the Internet, or a private network such as a local area network (LAN) or wide area network (WAN), or any combination thereof and can also include Public Switched Telephone Network (PSTN) or Integrated Services Digital Network (ISDN) sub-networks. The network 550 can also be wired, such as an Ethernet network, universal serial bus (USB) cable, or can be wireless such as a cellular network including EDGE, 3G and 4G wireless cellular systems. The wireless network can also be Wi-Fi, wireless LAN, Bluetooth, or any other wireless form of communication that is known. Additionally, network controller 306 may be compliant with other direct communication standards, such as Bluetooth, a near field communication (NFC), infrared ray or other.

The processing circuitry 300 further includes a display controller 308, such as a graphics card or graphics adaptor for interfacing with display 309, such as a monitor. An I/O interface 312 interfaces with a keyboard and/or mouse 314 as well as a touch screen panel 316 on or separate from display 309. I/O interface 312 also connects to a variety of peripherals 318.

The storage controller 324 connects the storage medium disk 304 with communication bus 326, which may be an ISA, EISA, VESA, PCI, or similar, for interconnecting all of the components of the processing circuitry 300. A description of the general features and functionality of the display 309, keyboard and/or mouse 314, as well as the display controller 308, storage controller 324, network controller 306, and I/O interface 312 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

What is claimed is:

1. An information processing system, comprising:
processing circuitry configured to
dynamically change a setting value of a first control parameter or a second control parameter, the first control parameter being for controlling proximation distance or collision among a plurality of virtual reality mediums in a three-dimensional (3D) virtual space, and the second control parameter being for controlling a position travelable by the plurality of virtual reality mediums in the 3D virtual space; and
control, in a case in which the setting value is changed, a position or an orientation of the plurality of the virtual reality mediums based on the setting value.

2. The information processing system according to claim 1, wherein
the plurality of virtual reality mediums include a plurality of avatars,
the first control parameter controls the proximation distance or collision among the plurality of avatars, and
the processing circuitry is further configured to
monitor a value of a predetermined parameter relating to the 3D virtual space, and
dynamically change the setting value based on a monitoring result of the value of the predetermined parameter.

3. The information processing system according to claim 2, wherein the processing circuitry is further configured to execute control relating to proximation distance or collision among the plurality of avatars based on the setting value of the first control parameter and position information of the plurality of avatars.

4. The information processing system according to claim 3, wherein, when executing the control relating to proximation distance or collision among the plurality of avatars, the processing circuitry is further configured to
execute a determination processing relating to proximation distance or collision among the plurality of avatars and
prevent a collision between the plurality of avatars or a proximation distance between the plurality of avatars to be less than a threshold from occurring based on a result of the determination processing.

5. The information processing system according to claim 3, wherein
the predetermined parameter includes a first parameter that represents or suggests a processing load of information processing relating to the 3D virtual space, and
the processing circuitry dynamically changes the setting value of the first control parameter such that control processing is turned off in a case in which the processing load is no less than a first predetermined threshold value.

6. The information processing system according to claim 3, wherein
the predetermined parameter includes a second parameter that represents or suggests a degree of friendship among the plurality of avatars, and
the processing circuitry dynamically changes the setting value of the first control parameter such that control processing is turned off with respect to two or more of the avatars of which the degree of friendship is no less than a second predetermined threshold value.

7. The information processing system according to claim 3, wherein
the predetermined parameter includes a third parameter that represents or suggests an attribute of the plurality of avatars, and
in a case in which one of the avatars has a predetermined attribute, the processing circuitry dynamically changes the setting value of the first control parameter such that control processing is turned on or off with respect to the one of the avatars.

8. The information processing system according to claim 3, wherein
the predetermined parameter includes a fourth parameter that represents or suggests an action attribute or a motion mode of the plurality of avatars, and
in a case in which the action attribute or the motion mode relates to an action or a motion of the plurality of avatars for a group event, the processing circuitry dynamically changes the setting value of the first control parameter such that control processing is turned off.

9. The information processing system according to claim 3, wherein
the predetermined parameter includes a fifth parameter that represents or suggests an avatar density in a particular region, and
in a case in which the avatar density is no less than a third predetermined threshold value, the processing circuitry dynamically changes the setting value of the first control parameter such that control processing is turned on in the particular region.

10. The information processing system according to claim 1, wherein
the processing circuitry is configured to monitor a value of a predetermined parameter relating to the 3D virtual space,
the plurality of virtual reality mediums include a plurality of avatars and a plurality of objects in the 3D virtual space,
the first control parameter controls proximation distance or collision among one of the avatars and one of the objects,
the processing circuitry is further configured to execute control relating to proximation distance or collision among the one of the objects and the one of the avatars based on the setting value of the first control parameter, position information of the one of the objects, and position information of the one of the avatars,
the predetermined parameter includes a sixth parameter that represents or suggests an input mode of a user that is associated with the one of the avatars, and
in a case in which the input mode is an input mode for construction or editing of the 3D virtual space, the processing circuitry dynamically changes the setting value of the first control parameter such that control processing is turned off

11. The information processing system according to claim 4, wherein the setting value of the first control parameter includes a first setting value that does not limit a distance among the plurality of avatars, and a second setting value that limits the distance among the plurality of avatars to become no greater than a predetermined distance.

11. The information processing system according to claim 11, wherein control processing is turned off in a case in which the setting value of the first control parameter is the first setting value, and is turned on in a case in which the setting value of the first control parameter is the second setting value.

11. The information processing system according to claim 11, wherein the processing circuitry sets the setting value in a form in which the setting value of the first control parameter differs for each of the plurality of avatars, or for each correlation among two of the avatars.

14. The information processing system according to claim 12, wherein
the predetermined parameter includes a second parameter that represents or suggests a degree of friendship among the plurality of avatars, and
the processing circuitry sets the predetermined distance such that the higher the degree of friendship among the plurality of avatars is, the smaller the predetermined distance is.

15. The information processing system according to claim 2, wherein
the setting value of the second control parameter includes a cost value that sets, for each position, a difficulty of the plurality of avatars to pass through, and that is associated with a plurality of positions, and
the processing circuitry is further configured to control positions travelable by the plurality of avatars by changing, based on the cost value, the difficulty of the plurality of avatars to pass through at each of the plurality of positions.

15. The information processing system according to claim 15, wherein the processing circuitry dynamically changes the cost value to form a waiting line by the plurality of avatars.

17. The information processing system according to claim 15, wherein
the predetermined parameter includes a fifth parameter that represents or suggests an avatar density in a particular region, and
the processing circuitry dynamically changes the cost value such that passage of the plurality of avatars is more difficult at places where the avatar density is relatively high as compared to places where the avatar density is relatively low.

18. An information processing method that is executed by a computer, the information processing method comprising:
dynamically changing a setting value of a first control parameter or a second control parameter, the first control parameter for controlling proximation distance or collision among a plurality of virtual reality mediums in a three-dimensional (3D) virtual space, and the second control parameter for controlling a position travelable by the plurality of virtual reality mediums in the 3D virtual space; and
controlling, in a case in which the setting value is changed, a position or an orientation of the plurality of the virtual reality mediums based on the setting value.

19. A non-transitory computer readable medium storing computer executable instructions which, when executed by a computer, cause the computer to execute a process comprising:
dynamically changing a setting value of a first control parameter or a second control parameter, the first control parameter for controlling proximation distance or collision among a plurality of virtual reality mediums in a three-dimensional (3D) virtual space, and the second control parameter for controlling a position travelable by the plurality of virtual reality mediums in the 3D virtual space; and
controlling, in a case in which the setting value is changed, a position or an orientation of the plurality of the virtual reality mediums based on the setting value.
